(19) United States
(12) Patent Application Publication
(10) Pub. No.: US 2015/0268825 A1
(43) Pub. Date: Sep. 24, 2015

(54) RENDERING OF A MEDIA ITEM

(71) Applicant: HERE Global B.V., LB Veldhoven (NL)

(72) Inventors: Sebastian FREY, Woodland Hills, CA (US); Pascal WEVER, Los Angeles, CA (US)

(21) Appl. No.: 14/218,826

(22) Filed: Mar. 18, 2014

(51) Int. Cl. G06F 3/0484; G06F 3/0485

(52) U.S. Cl. CPC G06F 3/04845; G06F 3/0485

(57) ABSTRACT

A method comprising causing rendering of a media item in a media item rendering region of a display, receiving information indicative of a first scope increase input in a scope increase direction, the first scope increase input being associated with the media item rendering region, and causing display of a criteria ordered set representation based, at least in part, on the first scope increase input, the criteria ordered set representation indicating a criteria ordered set of separate media items, and the criteria ordered set of separate media items comprising the media item and at least one related media item, such that the media item is associated with a criteria and the related media item is associated with the criteria is disclosed.

### TECHNICAL FIELD

The present application relates generally to rendering of a media item.

### BACKGROUND

As electronic apparatus become increasingly prevalent, many users of electronic apparatus utilize their respective electronic apparatuses for a variety of purposes. For example, a user of an electronic apparatus may utilize the user's electronic apparatus to view images, watch videos, and/or the like. As such, it may be desirable to configure an electronic apparatus such that a user may view images, watch videos, and/or the like, in an intuitive manner.

### SUMMARY

Various aspects of examples of the invention are set out in the claims.

One or more embodiments may provide an apparatus, a computer readable medium, a non-transitory computer readable medium, a computer program product, and a method for causing rendering of a media item in a media item rendering region of a display, receiving information indicative of a first scope increase input in a scope increase direction, the first scope increase input being associated with the media item rendering region, and causing display of a criteria ordered set representation based, at least in part, on the first scope increase input, the criteria ordered set representation indicating a criteria ordered set of separate media items, and the criteria ordered set of separate media items comprising the media item and at least one related media item, such that the media item is associated with a criteria and the related media item is associated with the criteria.

One or more embodiments may provide an apparatus, a computer readable medium, a computer program product, and a non-transitory computer readable medium having means for causing rendering of a media item in a media item rendering region of a display, means for receiving information indicative of a first scope increase input in a scope increase direction, the first scope increase input being associated with the media item rendering region, and means for causing display of a criteria ordered set representation based, at least in part, on the first scope increase input, the criteria ordered set representation indicating a criteria ordered set of separate media items, and the criteria ordered set of separate media items comprising the media item and at least one related media item, such that the media item is associated with a criteria and the related media item is associated with the criteria.

In at least one example embodiment, the causation of display of the criteria ordered set representation is performed absent intervening inputs between the receipt of the information indicative of the first scope increase input and the causation of display of the criteria ordered set representation.

One or more example embodiments further perform receipt of information indicative of a tap input that corresponds with a representation of a different media item comprised by the criteria ordered set, termination of display of the criteria ordered set representation based, at least in part, on the tap input, and causation of rendering of the different media item in the media item rendering region.

One or more example embodiments further perform receipt of information indicative of a scope decrease input in a scope decrease direction that is in a direction that is opposite to the scope increase direction, and termination of display of the criteria ordered set representation based, at least in part, on the scope decrease input.

In at least one example embodiment, the scope decrease input is a pinch input.

In at least one example embodiment, the pinch input comprises a contact portion of the pinch input, another contact portion of the pinch input, and a movement portion of the pinch input, and the scope decrease direction is an inward direction such that the contact portion of the pinch input moves closer to the other contact portion of the pinch input during the movement portion of the pinch input.

In at least one example embodiment, the scope decrease input is a drag input.

In at least one example embodiment, the drag input comprises a contact portion of the drag input, a movement portion of the drag input, and a release portion of the drag input, and the scope decrease direction is a downward direction with respect to an orientation of the display such that the release portion of the drag input corresponds with a position that is below a different position that corresponds with the contact portion of the drag input.

In at least one example embodiment, the scope decrease input is associated with the criteria ordered set representation.

In at least one example embodiment, the termination of display of the criteria ordered set representation comprises termination of display of at least a portion of the criteria ordered set representation on at least a portion of the display that is downward from the center of the media item rendering region of the display.

In at least one example embodiment, the termination of display of the criteria ordered set representation comprises display of the criteria ordered set representation at a first position on the display and display of the criteria ordered set representation at a second position on the display, such that the criteria ordered set representation transitions from the first position to the second position in a downward direction such that display of at least a portion of the criteria ordered set representation is terminated.

One or more example embodiments further perform receipt of information indicative of a second scope increase input in the scope increase direction, and causation of display of a cross-criteria ordered set representation based, at least in part, on the second scope increase input, the cross-criteria ordered set representation indicating a cross-criteria ordered set of separate media items, and the cross-criteria ordered set of separate media items comprising the criteria ordered set of separate media items and at least one unrelated media item, the unrelated media item being absent an association with the criteria.

In at least one example embodiment, the second scope increase input is associated with the criteria ordered set representation.

In at least one example embodiment, the second scope increase input is associated with the media item rendering region of the display.

One or more example embodiments further perform termination of display of the criteria ordered set representation based, at least in part, on the second scope increase input.

One or more example embodiments further perform termination of display of the criteria ordered set representation based, at least in part, on the causation of display of the cross-criteria ordered set representation.

One or more example embodiments further perform receipt of information indicative of a scope decrease input in a scope decrease direction that is in a direction that is opposite to the scope increase direction, and termination of display of the cross-criteria ordered set representation based, at least in part, on the scope decrease input.

One or more example embodiments further perform termination of display of the criteria ordered set representation based, at least in part, on the scope decrease input.

One or more example embodiments further perform causation of display of the criteria ordered set representation based, at least in part, on the scope decrease input.

One or more example embodiments further perform receipt of information indicative of a perpendicular input in a direction that is perpendicular to the scope increase direction, the perpendicular input being associated with the cross-criteria ordered set representation, and causation of scrolling of the cross-criteria ordered set representation in proportion to the perpendicular input.

In at least one example embodiment, the scrolling of the cross-criteria ordered set representation comprises panning of the cross-criteria ordered set representation.

In at least one example embodiment, the causation of display of the cross-criteria ordered set representation comprises display of a portion of the cross-criteria ordered set representation and panning of the cross-criteria ordered set representation comprises determination of a different portion of the cross-criteria ordered set representation and display of the different portion of the cross-criteria ordered set representation.

One or more example embodiments further perform causation of display of a cross-criteria ordered set representation navigation interface element based, at least in part, on the second scope increase input.

One or more example embodiments further perform causation of display of a cross-criteria ordered set representation navigation interface element based, at least in part, on the causation of display of the cross-criteria ordered set representation.

One or more example embodiments further perform receipt of information indicative of a perpendicular input in a direction that is perpendicular to the scope increase direction, the perpendicular input being associated with the cross-criteria ordered set representation navigation interface element, and causation of scrolling of the cross-criteria ordered set representation in proportion to the perpendicular input.

One or more example embodiments further perform receipt of information indicative of a tap input at a position along the cross-criteria ordered set representation navigation interface element that fails to correspond with a position of an index point along the cross-criteria ordered set representation navigation interface element, and causation of movement of the index point in relation to the cross-criteria ordered set representation navigation interface element such that the index point moves to a position along the cross-criteria ordered set representation navigation interface element that corresponds with the position of the tap input along the cross-criteria ordered set representation navigation interface element.

In at least one example embodiment, the criteria ordered set representation is single row of representative images of a plurality of separate media items comprised by the criteria ordered set, and the cross-criteria ordered set representation is multiple rows of representative images of a plurality of separate media items comprised by the cross-criteria ordered set.

One or more example embodiments further perform receipt of information indicative of a tap input that corresponds with a representation of a different media item comprised by the cross-criteria ordered set, termination of display of the cross-criteria ordered set representation based, at least in part, on the tap input, and causation of rendering of the different media item in the media item rendering region.

One or more example embodiments further perform receipt of information indicative of a perpendicular input in a direction that is perpendicular to the scope increase direction, the perpendicular input being associated with the criteria ordered set representation, and causation of scrolling of the criteria ordered set representation in proportion to the perpendicular input.

In at least one example embodiment, the scrolling of the criteria ordered set representation comprises panning of the criteria ordered set representation.

In at least one example embodiment, the causation of display of the criteria ordered set representation comprises display of a portion of the criteria ordered set representation and panning of the criteria ordered set representation comprises determination of a different portion of the criteria ordered set representation and display of the different portion of the criteria ordered set representation.

One or more example embodiments further perform receipt of information indicative of a perpendicular input in a direction that is perpendicular to the scope increase direction, the perpendicular input being associated with the media item rendering region, and causation of change of a rendering position of the media item in proportion to the perpendicular input.

One or more example embodiments further perform causation of rendering of a portion of the media item indicated by the rendering position.

In at least one example embodiment, the rendering position designates a part of the media item to be rendered.

In at least one example embodiment, the rendering position designates a timestamp of the media item, and causation of rendering of the portion of the media item indicated by the rendering position comprises rendering of a frame of the media item that corresponds with the timestamp of the media item.

In at least one example embodiment, the causation of display of the criteria ordered set representation comprises overlay of the criteria ordered set representation on a portion of the media item rendering region that is in a direction from a center of the media item rendering region that is opposite the scope increase direction.

One or more example embodiments further perform receipt of information indicative of a tap input that corresponds with the media item rendering region of the display, and termination of display of the criteria ordered set representation based, at least in part, on the tap input.

In at least one example embodiment, the scope increase input is a pinch input.

In at least one example embodiment, the pinch input comprises a contact portion of the pinch input, another contact portion of the pinch input, and a movement portion of the pinch input, and the scope increase direction is an outward direction such that the contact portion of the pinch input moves further from the other contact portion of the pinch input during the movement portion of the pinch input.

In at least one example embodiment, the scope increase input is a drag input.

In at least one example embodiment, the drag input comprises a contact portion of the drag input, a movement portion of the drag input, and a release portion of the drag input, and the scope increase direction is an upward direction with respect to an orientation of the display such that the release portion of the drag input corresponds with a position that is above a different position that corresponds with the contact portion of the drag input.

In at least one example embodiment, the display of the criteria ordered set representation comprises display of at least a portion of the criteria ordered set representation on at least a portion of the display that is downward from the center of the media item rendering region of the display.

In at least one example embodiment, the display of the criteria ordered set representation comprises display of the criteria ordered set representation at a first position on the display and display of the criteria ordered set representation at a second position on the display, such that the criteria ordered set representation transitions from the first position to the second position in an upward direction.

In at least one example embodiment, the criteria ordered set representation is associated with the criteria.

In at least one example embodiment, the criteria indicates at least one of a moment, an event, a time, a date, a location, or a tag.

In at least one example embodiment, the criteria ordered set representation comprises at least a representative image that represents the media item and another representative image that represents the related media item.

In at least one example embodiment, the cross-criteria ordered set representation comprises at least a representative image that represents the media item, another representative image that represents the related media item, and a different representative image that represents the unrelated media item.

In at least one example embodiment, the cross-criteria ordered set representation is associated with a representative image gallery user interface.

In at least one example embodiment, the cross-criteria ordered set representation is associated with a representative image hierarchical user interface.

In at least one example embodiment, a representative image is at least one of a thumbnail image, a gallery image, a cropped image, or a scaled image.

In at least one example embodiment, a representative image is an image that represents at least one of a photo, a video, or a video segment.

In at least one example embodiment, the causation of display of the criteria ordered set representation comprises resizing of the media item rendering region in proportion to a size of a dimension of the criteria ordered set representation, and display of the criteria ordered set representation.

In at least one example embodiment, the media item rendering region of the display is a region of the display that is associated with rendering of the media item.

In at least one example embodiment, the media item is an image media item, and rendering of the media item comprises display of the image within the media item rendering region of the display.

In at least one example embodiment, the media item is a video media item, and rendering of the media item comprises display of at least a frame of the video media item within the media item rendering region of the display.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus according to at least one example embodiment;

FIGS. 2A-2B are diagrams illustrating apparatus orientation according to at least one example embodiment;

FIGS. 3A-3H are diagrams illustrating a media item rendering region, a criteria ordered set representation, and/or a cross-criteria ordered set representation according to at least one example embodiment;

FIG. 4 is a flow diagram illustrating activities associated with causation of display of a criteria ordered set representation based, at least in part, on a scope increase input according to at least one example embodiment;

FIG. 5 is a flow diagram illustrating activities associated with termination of display of a criteria ordered set representation based, at least in part, on a scope decrease input according to at least one example embodiment;

FIG. 6 is a flow diagram illustrating activities associated with causation of display of a cross-criteria ordered set representation based, at least in part, on a scope increase input according to at least one example embodiment;

FIG. 7 is a flow diagram illustrating activities associated with causation of rendering of a media item in a media item rendering region according to at least one example embodiment;

FIG. 8 is a flow diagram illustrating activities associated with causation of changing of a rendering position of a media item in proportion to a perpendicular input according to at least one example embodiment; and

FIG. 9 is a flow diagram illustrating activities associated with causation of scrolling of a criteria ordered set representation in proportion to a perpendicular input according to at least one example embodiment.

### DETAILED DESCRIPTION OF THE DRAWINGS

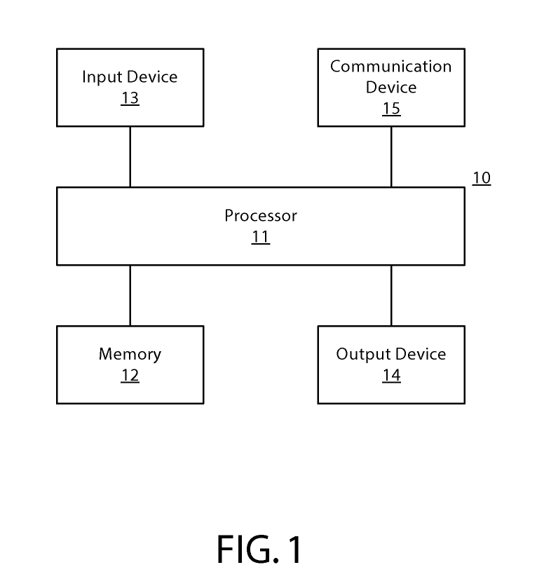

An embodiment of the invention and its potential advantages are understood by referring to FIGS. 1 through 9 of the drawings.

Some embodiments will now be described more fully hereinafter with reference to the accompanying drawings, in which some, but not all, embodiments are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses may readily employ embodiments of the invention. Electronic apparatus 10 may be a personal digital assistant (PDAs), a pager, a mobile computer, a desktop computer, a television, a gaming apparatus, a laptop computer, a tablet computer, a media player, a camera, a video recorder, a mobile phone, a global positioning system (GPS) apparatus, an automobile, a kiosk, an electronic table, and/or any other types of electronic systems. Moreover, the apparatus of at least one example embodiment need not be the entire electronic apparatus, but may be a component or group of components of the electronic apparatus in other example embodiments. For example, the apparatus may be an integrated circuit, a set of integrated circuits, and/or the like.

Furthermore, apparatuses may readily employ embodiments of the invention regardless of their intent to provide mobility. In this regard, even though embodiments of the invention may be described in conjunction with mobile applications, it should be understood that embodiments of the invention may be utilized in conjunction with a variety of other applications, both in the mobile communications industries and outside of the mobile communications industries. For example, the apparatus may be, at least part of, a non-carryable apparatus, such as a large screen television, an electronic table, a kiosk, an automobile, and/or the like.

In at least one example embodiment, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output device 14 may comprise a visual output device, such as a display, a light, and/or the like. In at least one example embodiment, the apparatus causes display of information, the causation of display may comprise displaying the information on a display comprised by the apparatus, sending the information to a separate apparatus that comprises a display, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like. In at least one example embodiment, the apparatus receives an indication of an input. The apparatus may receive the indication from a sensor, a driver, a separate apparatus, and/or the like. The information indicative of the input may comprise information that conveys information indicative of the input, indicative of an aspect of the input indicative of occurrence of the input, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

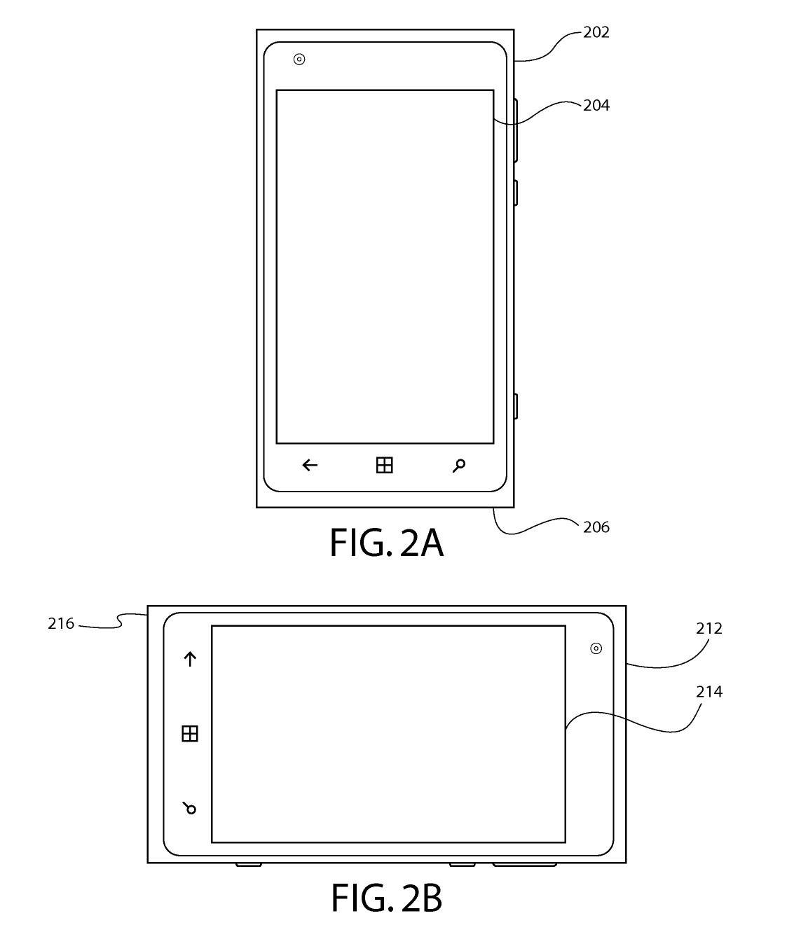

FIGS. 2A-2B are diagrams illustrating apparatus orientation according to at least one example embodiment. The examples of FIGS. 2A-2B are merely examples and do not limit the scope of the claims. For example, apparatus design may vary, apparatus configuration may vary, apparatus orientation may vary, and/or the like.

In many circumstances, a user may desire to utilize and/or interact with an electronic apparatus. For example, the user may desire to perceive a media item by way of the user's electronic apparatus. The media item may, for example, be an image media item, a video media item, and/or the like. In such an example, the user may desire to view an image media item, watch a video media item, and/or the like.

In many circumstances, a user may desire to interact with the user's apparatus in an easy and intuitive manner. In such an example embodiment, the user may view an image that is displayed on the display, may interact with one or more interface elements that may be displayed on the display, and/or the like. In some circumstances, a user of the electronic apparatus may hold the electronic apparatus in the user's hands, may place the electronic apparatus on a surface, and/or the like. In such circumstances, the electronic apparatus may be held such that the electronic apparatus is oriented in various orientations. For example, although a particular apparatus may have a predetermined top and/or bottom of the electronic apparatus, the user may hold the electronic apparatus such that the electronic apparatus is on a side of the electronic apparatus that fails to correspond with the top and/or the bottom of the electronic apparatus. In such an example, it may be desirable to display visual content on the display of the electronic apparatus based, at least in part, on an orientation of the display. In this manner, the visual content that is displayed on the display may be legible, right side up, and/or the like, regardless of the orientation of the electronic apparatus.

FIG. 2A is a diagram illustrating an apparatus orientation according to at least one example embodiment. The example of FIG. 2A illustrates apparatus 202. As can be seen, apparatus 202 comprises display 204. In the example of FIG. 2A, display 204 is oriented in an orientation such that side 206 corresponds with the bottom of apparatus 202. For example, apparatus 202 may be designed, manufactured, configured, and/or the like, such that side 206 is intended to be the bottom of apparatus 202, held such that side 206 is facing downward, and/or the like. In at least one example embodiment, FIG. 2A illustrates apparatus 202 in a portrait orientation. A portrait orientation may be an orientation of display 204 in which the height dimension of display 204 is greater than the width dimension of display 204. As such, a media item displayed on display 204 may be displayed such that a user holding apparatus 202 in the depicted orientation perceives the media item to be right side up, correctly oriented, and/or the like. In the example of FIG. 2A, an upward direction with respect to the orientation of apparatus 202 is a direction from side 206 towards the top of apparatus 202, perpendicular to side 206. Similarly, a downward direction with respect to the orientation of apparatus 202 is a direction from the top of apparatus 202 towards side 206, perpendicular to side 206.

FIG. 2B is a diagram illustrating an apparatus orientation according to at least one example embodiment. The example of FIG. 2B illustrates apparatus 212. As can be seen, apparatus 212 comprises display 214. In the example of FIG. 2B, display 214 is oriented in an orientation such that side 216 fails to corresponds with the bottom of apparatus 212. For example, apparatus 212 may be designed, manufactured, configured, and/or the like, such that side 216 is intended to be the bottom of apparatus 212, held such that side 216 is facing downward, and/or the like. As can be seen, apparatus 212 is oriented such that side 216 is facing a direction perpendicular to the direction side 206 is facing in the example of FIG. 2A. In at least one example embodiment, FIG. 2B illustrates apparatus 212 in a landscape orientation. A landscape orientation may be an orientation of display 214 in which the height dimension of display 214 is less than the width dimension of display 214. As such, a media item displayed on display 214 may be displayed such that a user holding apparatus 212 in the depicted orientation perceives the media item to be right side up, correctly oriented, and/or the like. In the example of FIG. 2B, an upward direction with respect to the orientation of apparatus 212 is a direction from the lower side of apparatus 216 towards the upper side of apparatus 212, parallel to side 216. Similarly, a downward direction with respect to the orientation of apparatus 212 is a direction from the upper side of apparatus 212 towards the lower side of apparatus 202, perpendicular to side 216.

As can be seen, the upward direction and the downward direction remain similar between the orientation illustrated in FIG. 2A and the orientation illustrated in FIG. 2B. The relationship between the upward direction and the apparatus, and the downward direction and the apparatus, is changed based, at least in part, on the orientation of the apparatus.

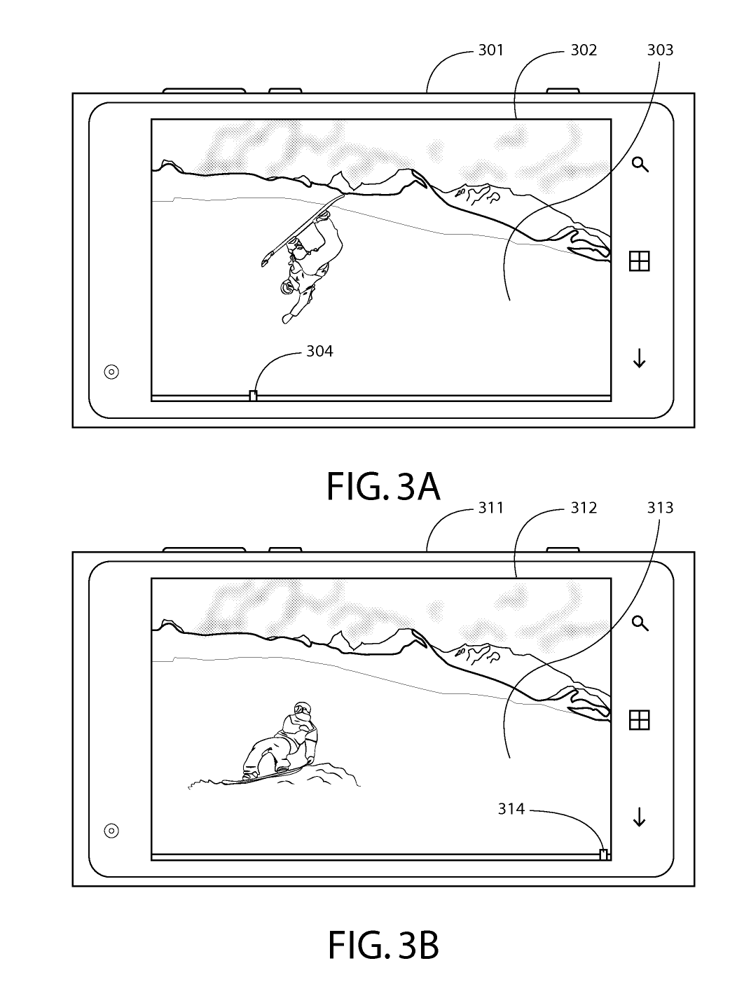

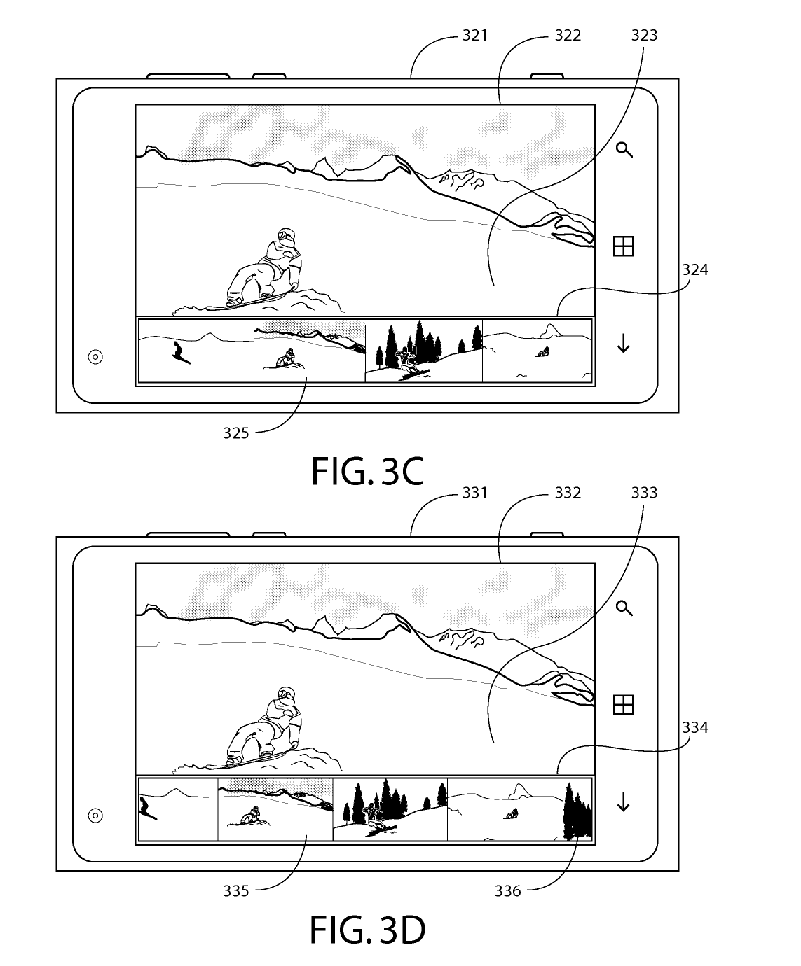

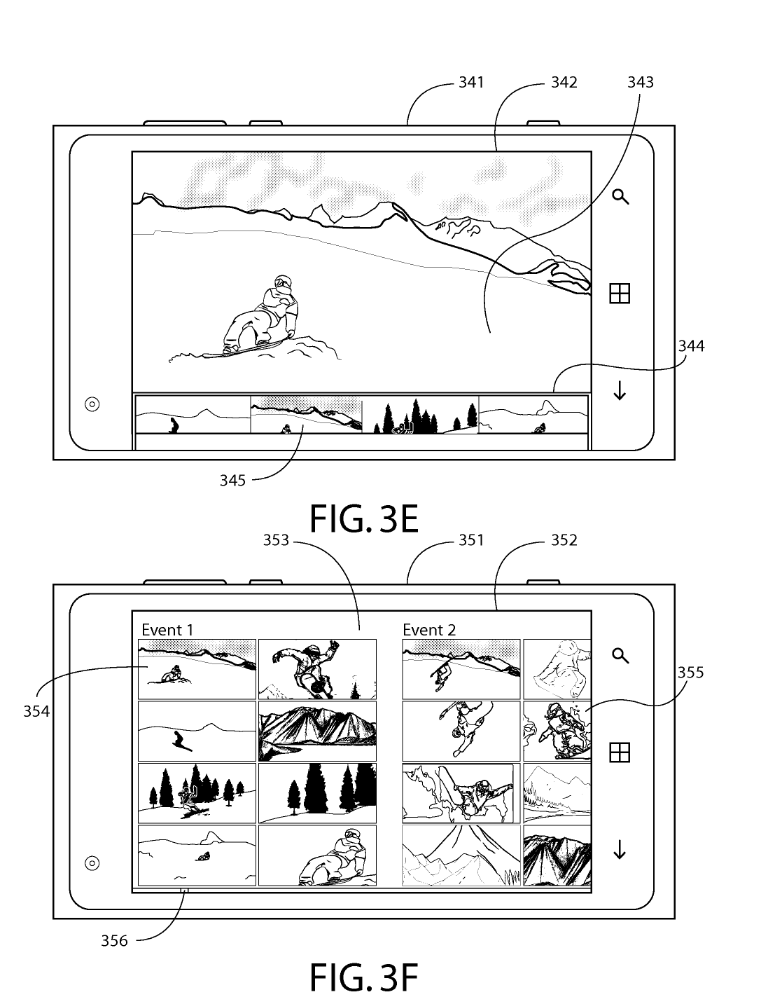

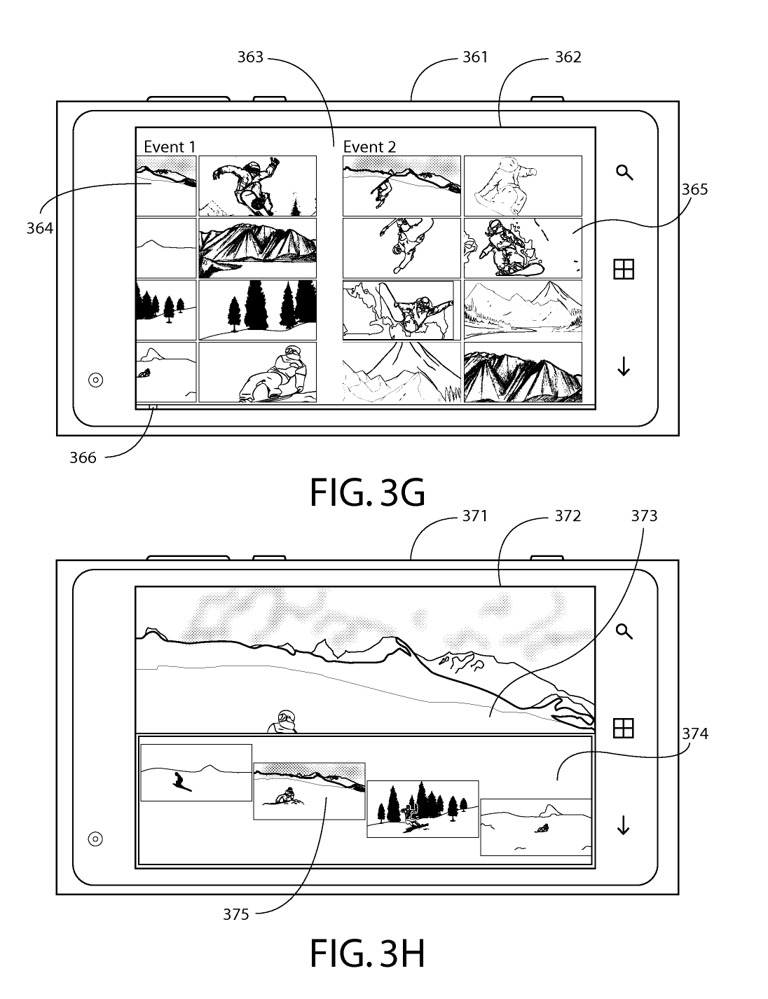

FIGS. 3A-3H are diagrams illustrating a media item rendering region, a criteria ordered set representation, and/or a cross-criteria ordered set representation according to at least one example embodiment. The examples of FIGS. 3A-3H are merely examples and do not limit the scope of the claims. For example, apparatus design may vary, apparatus configuration may vary, display content may vary, ordered set representations may vary, representative images may vary, and/or the like.

As discussed previously, in many circumstances, a user of an electronic apparatus may desire to have the user's electronic apparatus render a media item. For example, the user may desire to view an image media item, watch a video media item, and/or the like. In at least one example embodiment, an apparatus causes rendering of a media item. In some circumstances, rendering of a media item may be associated with display of one or more interface elements, toolbars, sliders, and/or the like. As such, rendering of the media item may comprise rendering of the media item in a media item rendering region of a display. The media item rendering region of the display may be a region of the display that is associated with rendering of media items. For example, the media item may be an image media item, and rendering of the media item may comprise display of the image within the media item rendering region of the display. In another example, the media item may be a video media item, and rendering of the media item may comprise display of at least a frame of the video media item within the media item rendering region of the display.

FIG. 3A is a diagram illustrating a media item rendering region according to at least one example embodiment. The example of FIG. 3A illustrates apparatus 301. As can be seen, apparatus 301 comprises display 302. In the example of FIG. 3A, apparatus 301 is oriented similar to apparatus 212 of FIG. 2B. As illustrated, media item rendering region 303 of display 302 is associated with a rendering of a snowboarder. In the example of FIG. 3A, the rendering of the snowboarder may be associated with rendering of an image media item, rendering of a frame of a video media item, and/or the like.

In many circumstances, a user may watch a video media item by way of the user's electronic apparatus. In such circumstances, a user may desire to navigate through the video media item by way of the user's electronic apparatus, one or more interface elements, and/or the like. For example, the user may desire to fast forward through a portion of the video media item, rewind through a portion of the video media item, indicate a desired playback position within the video media item, and/or the like. In such circumstances, it may be desirable to configure the electronic apparatus such that the electronic apparatus may fast forward through a portion of the video media item, rewind through a portion of the video media item, jump to a specific playback position within the video media item, and/or the like.

In at least one example embodiment, an apparatus causes change of a rendering position of the media item. In such an example embodiment, the apparatus may cause rendering of at least a portion of the media item indicated by the rendering position. For example, the rendering position may designate a part of the media item to be rendered, and rendering of the media item may comprise rendering of the media item from the designated part of the media item. For example, the rendering position may designate a timestamp of the media item, and causation of rendering of the portion of the media item indicated by the rendering position may comprise rendering of a frame of the media item that corresponds with the timestamp of the media item, rendering of the media item from the frame of the media item, and/or the like.

In the example of FIG. 3A, representation 304 represents a rendering position that is associated with rendering of the visual content that is rendered in media item rendering region 303. For example, representation 304 may be displayed at a position along the illustrated axis such that the position of representation 304 is indicative of a rendering position, a timestamp of the rendered media item, and/or the like.

FIG. 3B is a diagram illustrating a media item rendering region according to at least one example embodiment. The example of FIG. 3B illustrates apparatus 311. As can be seen, apparatus 311 comprises display 312. In the example of FIG. 3B, apparatus 311 is oriented similar to apparatus 212 of FIG. 2B. As illustrated, media item rendering region 313 of display 312 is associated with a rendering of a snowboarder. In the example of FIG. 3B, the rendering of the snowboarder may be associated with rendering of an image media item, rendering of a frame of a video media item, and/or the like. As can be seen, FIG. 3A depicts a snowboarder that is performing a flip while midair. In the example of FIG. 3B, the snowboarder has completed performance of the flip and has landed. As such, FIG. 3B may illustrate an image media item that was captured at a time subsequent to the image media item illustrated in the example of FIG. 3A, may illustrate a frame of a video media item that is associated with a timestamp that is subsequent to a timestamp of the frame illustrated in FIG. 3A, and/or the like.

In the example of FIG. 3B, representation 314 represents a rendering position that is associated with rendering of the visual content that is rendered in media item rendering region 313. For example, representation 314 may be displayed at a position along the illustrated axis such that the position of representation 314 is indicative of a rendering position, a timestamp of the rendered media item, and/or the like. As can be seen, representation 314 of FIG. 3B is further to the right than representation 304 of FIG. 3A. For example, FIG. 3A and FIG. 3B may each illustrate rendering of an image media item in a media item rendering region, and representation 314 may indicate that the image media item of FIG. 3B is arranged in an ordered set of media items such that the media item of FIG. 3B is arranged after the media item of FIG. 3A. In another example, FIG. 3A and FIG. 3B may each illustrate rendering of a single video media item. In such an example, FIG. 3A may illustrate rendering of a frame of the video media item, and FIG. 3B may illustrate rendering of a different frame of the video media item that is subsequent to the frame of the video media item. In this manner, the position of representation 314 to the right of the position of representation 304 in FIG. 3A may be indicative of a rendering position in FIG. 3B that is subsequent to a rendering position of FIG. 3A, a timestamp of the frame that is rendered in FIG. 3B that is subsequent to a timestamp of the different frame that is rendered in FIG. 3A, and/or the like.

In many circumstances, a user may desire to view multiple image media items, watch multiple video media items, and/or the like. For example, a user may have went on a snowboarding vacation, and may desire to view media items that are associated with the snowboarding vacation, were captured during the snowboarding vacation, and/or the like. In such circumstances, it may be desirable to configure an apparatus such that a user of the apparatus may quickly and intuitively browse through a plurality of media items, differentiate between media items, indicate a desire to render a specific media item, and/or the like. In at least one example embodiment, an apparatus causes display of a criteria ordered set representation. In such an example embodiment, the criteria ordered set representation may indicate a criteria ordered set of separate media items. The criteria ordered set of separate media items may, for example, comprise a media item, a related media item, a video media item, an image media item, and/or the like. In such an example, the criteria ordered set representation may comprise a representative image that represents a media item, another representative image that represents the related media item, and/or the like. The representative image may be a thumbnail image, a gallery image, a cropped image, a scaled image, a frame image, and/or the like. For example, the representative image may be an image that represents a photo, a video, a video segment, and/or the like. For example, the criteria ordered set may comprise a video media item, and the criteria ordered set representation may comprise a representative image that is based, at least in part, on a frame of the video media item. In such an example, the representative image may be a cropped version of the frame of the video media item, a scaled version of the frame of the video media item, and/or the like. In another example, the criteria ordered set may comprise an image media item, and the criteria ordered set representation may comprise a representative image that is based, at least in part, on the image media item. In such an example, the representative image may be a cropped version of the image media item, a scaled version of the image media item, and/or the like. In at least one example embodiment, the criteria ordered set representation is single row of representative images of a plurality of separate media items comprised by the criteria ordered set.

As discussed previously, a user of an electronic apparatus may desire to view media items that are associated with a particular event, that were captured on a specific date, and/or the like. For example, the user in the previous example may desire to view media items that are associated with the user's snowboarding adventure. As such, it may be desirable to configure an electronic apparatus such that the electronic apparatus may group one or more media items based, at least in part, on an attribute of the media item. In at least one example embodiment, the criteria ordered set is associated with at least one criteria. The criteria may indicate a moment, an event, a time, a date, a location, a tag, and/or the like. For example, the criteria ordered set of separate media items may comprise a media item and a related media item such that the media item is associated with a criteria and the related media item is associated with the criteria. In such an example, the criteria ordered set of separate media items may fail to comprise a media item that fails to be associated with the criteria. As such, a criteria ordered set representation may be associated with the criteria such that the criteria ordered set representation comprises representative images that represent media items that are associated with the criteria, and fails to comprise representative images that represent different media items that fail to be associated with the criteria.

In many circumstances, a user of an electronic apparatus may desire to perceive a criteria ordered set representation in relation to a media item rendering region of a display. For example, the user may desire to view a media item that is rendered in the media item rendering region in relation to the criteria ordered set representation, may desire to navigate through the criteria ordered set representation in reference to the media item that is being rendered, may desire to quickly shift between navigating through the criteria ordered set representation and perceiving the rendered media item, and/or the like. As such, it may be desirable to configure an electronic apparatus such that the electronic apparatus causes display of a criteria ordered set representation on a display in relation to a media item rendering region of the display. In at least one example embodiment, an apparatus causes display of a criteria ordered set representation such that the criteria ordered set representation overlays a portion of a media item rendering region. In such an example, the criteria ordered set representation may obstruct view of the portion of the media item rendering region. In at least one example embodiment, causation of display of a criteria ordered set representation comprises resizing of a media item rendering region in proportion to a size of a dimension of the criteria ordered set representation, and display of the criteria ordered set representation. For example, the criteria ordered set representation may have a particular height when displayed on a display, and the media item rendering region of the display may be resized in proportion to the particular height. In such an example, the height of the media item rendering region may be reduced by the height of the criteria ordered set representation, may be reduced in proportion to the height of the criteria ordered set representation, and/or the like. In another example, the criteria ordered set representation have a particular width when displayed on a display, and the media item rendering region of the display may be resized in proportion to the particular width. In such an example, the width of the media item rendering region may be reduced by the width of the criteria ordered set representation, may be reduced in proportion to the width of the criteria ordered set representation, and/or the like.

FIG. 3C is a diagram illustrating a criteria ordered set representation according to at least one example embodiment. The example of FIG. 3C illustrates apparatus 321. As can be seen, apparatus 321 comprises display 322. In the example of FIG. 3C, apparatus 321 is oriented similar to apparatus 212 of FIG. 2B. As illustrated, media item rendering region 323 of display 322 is associated with a rendering of a snowboarder. In the example of FIG. 3C, the rendering of the snowboarder may be associated with rendering of an image media item, rendering of a frame of a video media item, and/or the like. As can be seen, the rendering of the snowboarder in FIG. 3C corresponds with the rendering of the snowboarder in FIG. 3B. In the example of FIG. 3C, criteria ordered set representation 324 is displayed on display 322. As can be seen, media item rendering region 323 in FIG. 3C is smaller than media item rendering region 313 in FIG. 3B. In this manner, in the example of FIG. 3C, criteria ordered set representation 324 may overlay a portion of media item rendering region 323, media item rendering region 323 may have been resized in proportion to a height of criteria ordered set representation 324, and/or the like. In the example of FIG. 3C, criteria ordered set representation comprises representative image 325, and at least three other representative images. Representative image 325 may be a frame of the media item being rendered in media item rendering region 323, may be a scaled version of the media item being rendered in media item rendering region 323, and/or the like. As can be seen, each representative image depicts an image that is associated with snowboarding. As such, the criteria ordered set of separate media items that is indicated by criteria ordered set representation 324 may be associated with a criteria that indicates a particular date range that is associated with the snowboarding vacation, a tag that is indicative of a media item associated with the snowboarding trip, and/or the like. As can be seen, the representative images are arranged in a single row.

In some circumstances, a criteria ordered set representation may be dimensioned such that an electronic apparatus may be precluded from displaying of the entirety of the criteria ordered set representation. For example, the criteria ordered set representation may be too wide to be displayed in its entirety on a display of the electronic apparatus, may be too tall to be displayed in its entirety on the display, and/or the like. As such, it may be desirable to configure an electronic apparatus such that the electronic apparatus may display a portion of a criteria ordered set representation in a manner that allows for navigation within the criteria ordered set representation, display of a different portion of the criteria ordered set representation, and/or the like. In at least one example embodiment, an apparatus causes display of a portion of a criteria ordered set representation. In such an example embodiment, the apparatus may display the portion of the criteria ordered set representation such that the criteria ordered set representation may be panned, scrolled, and/or the like. In such an example, panning of the criteria ordered set representation may comprise determination of a different portion of the criteria ordered set representation, and causation of display of the different portion of the criteria ordered set representation. In this manner, the entirety of the criteria ordered set representation may be selectively displayed, navigated through, panned across, and/or the like.

FIG. 3D is a diagram illustrating a criteria ordered set representation according to at least one example embodiment. The example of FIG. 3D illustrates apparatus 331. As can be seen, apparatus 331 comprises display 332. In the example of FIG. 3D, apparatus 331 is oriented similar to apparatus 212 of FIG. 2B. As illustrated, media item rendering region 333 of display 332 is associated with a rendering of a snowboarder. In the example of FIG. 3D, the rendering of the snowboarder may be associated with rendering of an image media item, rendering of a frame of a video media item, and/or the like. As can be seen, the rendering of the snowboarder in FIG. 3D corresponds with the rendering of the snowboarder in FIG. 3B. In the example of FIG. 3D, criteria ordered set representation 334 is displayed on display 332. As can be seen, media item rendering region 333 in FIG. 3D is smaller than media item rendering region 313 in FIG. 3B. In this manner, in the example of FIG. 3D, criteria ordered set representation 334 may overlay a portion of media item rendering region 333, media item rendering region 333 may have been resized in proportion to a height of criteria ordered set representation 334, and/or the like. In the example of FIG. 3D, criteria ordered set representation 324 comprises representative image 335, and at least three other representative images. Representative image 335 may be a frame of the media item being rendered in media item rendering region 333, may be a scaled version of the media item being rendered in media item rendering region 333, and/or the like. As can be seen, each representative image depicts an image that is associated with snowboarding. As such, the criteria ordered set of separate media items that is indicated by criteria ordered set representation 334 may be associated with a criteria that indicates a particular date range that is associated with the snowboarding vacation, a tag that is indicative of a media item associated with the snowboarding trip, and/or the like. As can be seen, the representative images are arranged in a single row.

In the example of FIG. 3D, criteria ordered set representation 334 corresponds with criteria ordered set representation 324 of FIG. 3C. As can be seen, the four representative image to the left in FIG. 3D correspond with the four representative image comprised by criteria ordered set representation 324 in FIG. 3C. In the example of FIG. 3D, criteria ordered set representation 334 comprises representative image 336. As can be seen, representative image 336 failed to be displayed in the example of FIG. 3C. In this manner, the portion of criteria ordered set representation 324 displayed in the example of FIG. 3C fails to correspond with the portion of criteria ordered set representation 334 displayed in the example of FIG. 3D. In this manner, the criteria ordered set representation may comprise one or more representative images in addition to the representative images illustrated in the example of FIG. 3D, but such additional representative images may fail to be displayed on display 332 based, at least in part, on a size of display 332, on a size of criteria ordered set representation 334, on a size of each of the representative images comprised by criteria ordered set representation 334, and/or the like. As such, criteria ordered set representation 334 of FIG. 3D may correspond with criteria ordered set representation 324 of FIG. 3C subsequent to determination of and display of a different portion of the criteria ordered set representation. For example, criteria ordered set representation 324 of FIG. 3C may be a portion of a particular criteria ordered set representation, and criteria ordered set representation 334 of FIG. 3D may be a different portion of the particular criteria ordered set representation.

In some circumstances, it may be desirable to display of a criteria ordered set representation, to initiate display of a criteria ordered set representation, and/or the like. In such circumstances, a user of the electronic apparatus may desire such display of the criteria ordered set representation to be performed in a manner which is aesthetically appealing, visually smooth, and/or the like. As such, it may be desirable to animate a transition to display of a criteria ordered set representation, a transition between an absence of display of a criteria ordered set representation and display of the criteria ordered set representation, and/or the like. In at least one example embodiment, display of a criteria ordered set representation comprises display of at least a portion of the criteria ordered set representation on at least a portion of the display that is downward from the center of the media item rendering region of the display. In such an example, the apparatus may cause display of the portion of the criteria ordered set representation at a first position on the display and, subsequently, cause display of the portion of the criteria ordered set representation at a second position on the display, such that the criteria ordered set representation transitions from the first position to the second position in an upward direction. In this manner, the criteria ordered set representation may appear to transition onto the display from the bottom edge of the display in an upward direction, until the entirety of the portion of the criteria ordered set representation is displayed.

In some circumstances, it may be desirable to discontinue display of a criteria ordered set representation, to terminate display of a criteria ordered set representation, and/or the like. In such circumstances, a user of the electronic apparatus may desire such termination of display of the criteria ordered set representation to be performed in a manner which is aesthetically appealing, visually smooth, and/or the like. As such, it may be desirable to animate a transition to discontinuation of display of a criteria ordered set representation, a transition between display of a criteria ordered set representation and termination of display of the criteria ordered set representation, and/or the like. In at least one example embodiment, termination of display of a criteria ordered set representation comprises termination of display of at least a portion of the criteria ordered set representation on at least a portion of the display. In such an example embodiment, the portion of the display may be a portion of the display that is downward from the center of the media item rendering region of the display. In at least one example embodiment, termination of display of a criteria ordered set representation comprises display of at least a portion of the criteria ordered set representation at a first position on the display and display of the portion of criteria ordered set representation at a second position on the display, such that the criteria ordered set representation transitions from the first position to the second position in a downward direction such that display of at least a portion of the criteria ordered set representation is terminated. In this manner, the criteria ordered set representation may appear to transition off of the display at the bottom edge of the display in a downward direction, until display of the entirety of the portion of the criteria ordered set representation is termination.

FIG. 3E is a diagram illustrating a criteria ordered set representation according to at least one example embodiment. The example of FIG. 3E illustrates apparatus 341. As can be seen, apparatus 341 comprises display 342. In the example of FIG. 3E, apparatus 341 is oriented similar to apparatus 212 of FIG. 2B. As illustrated, media item rendering region 343 of display 342 is associated with a rendering of a snowboarder. In the example of FIG. 3E, the rendering of the snowboarder may be associated with rendering of an image media item, rendering of a frame of a video media item, and/or the like. As can be seen, the rendering of the snowboarder in FIG. 3E corresponds with the rendering of the snowboarder in FIG. 3B. In the example of FIG. 3E, criteria ordered set representation 344 is displayed on display 342. As can be seen, media item rendering region 343 in FIG. 3E is smaller than media item rendering region 313 in FIG. 3B. In this manner, in the example of FIG. 3E, criteria ordered set representation 344 may overlay a portion of media item rendering region 343, media item rendering region 343 may have been resized in proportion to a height of criteria ordered set representation 344, and/or the like. As can be seen, media item rendering region 343 in FIG. 3E is larger than media item rendering region 323 in FIG. 3C. As such, only a portion of criteria ordered set representation 344 is displayed on display 342 in the example of FIG. 3E. As can be seen, criteria ordered set representation 344 comprises representative image 345. In the example of FIG. 3E, only a portion of representative image 345 is displayed on display 342. In this manner, criteria ordered set representation 344 may be transitioning onto display 342, may be transitioning off of display 342, and/or the like. For example, criteria ordered set representation 344 may be transitioning onto display 342 based, at least in part, on display of criteria ordered set representation 344. In another example, criteria ordered set representation 344 may be transitioning off of display 342 based, at least in part, on termination of display of criteria ordered set representation 344.

As discussed previously, in many circumstances, a user of an electronic apparatus may desire to view media items, such as media items that are associated with a particular event, that were captured on a specific date, and/or the like. In some circumstances, a user's electronic apparatus may be associated with media items that relate to different events, which were captured on different dates, and/or the like. In such circumstances, the user of the electronic apparatus may desire to browse through the events, to view media items which are associated with different events and/or different dates, which were captured at various locations, and/or the like. As such, it may be desirable to configure an electronic apparatus such that a user of the electronic apparatus may navigate through a plurality of media items, view a particular media item, indicate a desire to cause rendering of a specific media item, and/or the like, in a manner which is easy and intuitive. In at least one example embodiment, an apparatus causes display of a cross-criteria ordered set representation. In such an example embodiment, the cross-criteria ordered set representation may indicate a cross-criteria ordered set of separate media items. For example, the cross-criteria ordered set of separate media items may comprise a criteria ordered set of separate media items, discussed previously, and at least one unrelated media item. In such an example, the unrelated media item may be a media item that is absent an association with the criteria. For example, the criteria ordered set of separate media items may comprise a media item and a related media item that are associated with a criteria, and the cross-criteria ordered set of separate media items may comprise the criteria ordered set of separate media items in addition to an unrelated media item that fails to be associated with the criteria. In this manner, the media item and the related media item may be associated with a particular event, a date, a location, and/or the like, and the unrelated media item may be associated with a different event, a different date, a different location, and/or the like.

In such circumstances, a user may desire to be able to view representative images that represent media items comprised by the cross-criteria ordered set of separate media items. For example, the user may desire to browse through the cross-criteria ordered set representation, identify a particular media item by way of a representative image that represents the media item, and/or the like. The cross-criteria ordered set of separate media items may, for example, comprise a media item, a related media item, an unrelated media item, and/or the like. In such an example, the cross-criteria ordered set representation may comprise a representative image that represents a media item, another representative image that represents the related media item, a different representative image that represents the unrelated media item, and/or the like. Each of the representative images may be a thumbnail image, a gallery image, a cropped image, a scaled image, a frame image, and/or the like. The cross-criteria ordered set representation may be associated with a representative image gallery user interface, a representative image hierarchical user interface, a media item gallery, an image gallery, a media item directory, and/or the like, such that a user may browse, identify, etc. a specific media item by way of a representative image that represents the media item. For example, the cross-criteria ordered set representation may be arranged into multiple rows of representative images that represent a plurality of separate media items that are comprised by the cross-criteria ordered set of separate media items.

In some circumstances, a cross-criteria ordered set of separate media items may comprise a large number of separate media items. In such circumstances, a cross-criteria ordered set representation that is indicative of the cross-criteria ordered set of separate media items may be dimensioned such that an electronic apparatus may be precluded from displaying of the entirety of the cross-criteria ordered set representation at once. For example, the cross-criteria ordered set representation may be too wide to be displayed in its entirety on a display of the electronic apparatus, may be too tall to be displayed in its entirety on the display, and/or the like. As such, it may be desirable to configure an electronic apparatus such that the electronic apparatus may display a portion of a cross-criteria ordered set representation in a manner that allows for navigation within the cross-criteria ordered set representation, display of a different portion of the cross-criteria ordered set representation, and/or the like. In at least one example embodiment, an apparatus causes display of a portion of a cross-criteria ordered set representation. In such an example embodiment, the apparatus may display the portion of the cross-criteria ordered set representation such that the cross-criteria ordered set representation may be panned, scrolled, and/or the like. In such an example, panning of the cross-criteria ordered set representation may comprise determination of a different portion of the cross-criteria ordered set representation, and causation of display of the different portion of the cross-criteria ordered set representation. In this manner, the entirety of the cross-criteria ordered set representation may be selectively displayed, navigated through, panned across, and/or the like.

In some circumstances, a user may desire to pan through a cross-criteria ordered set representation quickly and easily. For example, a cross-criteria ordered set representation may be dimensioned such that manually scrolling through the cross-criteria ordered set representation may be an undesirable method to navigate the cross-criteria ordered set representation. In at least one example embodiment, an apparatus causes display of a cross-criteria ordered set representation navigation interface element. The causation of display of a cross-criteria ordered set representation navigation interface element may be based, at least in part, on the causation of display of the cross-criteria ordered set representation, on a determination that the cross-criteria ordered set representation is too large to display in its entirety, and/or the like. In such an example embodiment, the apparatus may cause display of an index point at a position along the cross-criteria ordered set representation navigation interface element that is indicative of a scroll position of the cross-criteria ordered set representation, a portion of the cross-criteria ordered set representation that is displayed on a display, and/or the like. For example, panning of a cross-criteria ordered set representation may cause display of the cross-criteria ordered set representation to transition from display of a portion of the cross-criteria ordered set representation to display of a different portion of the cross-criteria ordered set representation. In such an example, the display of the portion of the cross-criteria ordered set representation may be associated with display of an index point at a position along the cross-criteria ordered set representation navigation interface element, and the display of the different portion of the cross-criteria ordered set representation may be associated with display of the index point at a different position along the cross-criteria ordered set representation navigation interface element. As such, transitioning from display of the portion of the cross-criteria ordered set representation to display of the different portion of the ordered set representation may cause movement of the index point from the position along the cross-criteria ordered set representation navigation interface element to the different position along the cross-criteria ordered set representation navigation interface element.

FIG. 3F is a diagram illustrating a cross-criteria ordered set representation according to at least one example embodiment. The example of FIG. 3F illustrates apparatus 351. As can be seen, apparatus 351 comprises display 352. In the example of FIG. 3F, apparatus 351 is oriented similar to apparatus 212 of FIG. 2B. In the example of FIG. 3F, cross-criteria ordered set representation 353 is displayed on display 352. In the example of FIG. 3F, cross-criteria ordered set representation 353 comprises representative image 354, and at least a portion of fifteen other representative images. Representative image 354 may be a frame of a media item associated with the cross-criteria ordered set of separate videos, may be a scaled version of the media item associated with the cross-criteria ordered set of separate videos, and/or the like. As can be seen, the representative images are grouped into two separate events. As such, the representative images grouped under “EVENT 1” may represent media items associated with an event, a date, a location, and/or the like, and the representative images grouped under “EVENT 2” may represent different media items associated with a different event, a different date, a different location, and/or the like. In this manner, the representative images grouped under “EVENT 1” may represent media items comprised by a criteria ordered set of separate media items, and the representative images grouped under “EVENT 2” may represent media items comprised by a different criteria ordered set of separate media items. As such, the cross-criteria ordered set of separate media items that is indicated by cross-criteria ordered set representation 353 may fail to be associated with a criteria, may be inclusive of all media items associated with apparatus 351, and/or the like. As can be seen, the representative images are arranged in a gallery format such that the representative images are arranged into rows and columns.

In the example of FIG. 3F, cross-criteria ordered set representation 334 comprises representative images that correspond with the representative images comprises by criteria ordered set representation 324 of FIG. 3C. As can be seen, the four representative image to the left in FIG. 3F correspond with the four representative image comprised by criteria ordered set representation 324 in FIG. 3C. In the example of FIG. 3F, cross-criteria ordered set representation 353 comprises representative image 354. As can be seen, representative image 354 corresponds with representative image 325 of FIG. 3C. In the example of FIG. 3F, cross-criteria ordered set representation 353 also comprises representative image 355. As can be seen, representative image 355 fails to correspond with a representative image comprised by criteria ordered set representation 324 of FIG. 3C. In this manner, representative image 355 may represent a media item that is an unrelated media item in context with criteria ordered set representation 324 of FIG. 3C.

FIG. 3G is a diagram illustrating a cross-criteria ordered set representation according to at least one example embodiment. The example of FIG. 3G corresponds with the scenario depicted in FIG. 3F. The example of FIG. 3G illustrates apparatus 361. As can be seen, apparatus 361 comprises display 362. In the example of FIG. 3G, apparatus 361 is oriented similar to apparatus 212 of FIG. 2B. In the example of FIG. 3G, cross-criteria ordered set representation 363 is displayed on display 362. In the example of FIG. 3G, cross-criteria ordered set representation 363 comprises representative image 364, and at least a portion of fifteen other representative images.

As can be seen in the example of FIG. 3F, representative image 355 failed to be displayed in its entirety. For example, in FIG. 3F, cross-criteria ordered set representation 353 may be dimensioned such that only a portion of cross-criteria ordered set representation 353 may be displayed on display 352. In this manner, the example of FIG. 3G may correspond with the scenario depicted in FIG. 3F subsequent to panning of cross-criteria ordered set representation of FIG. 3F to the position depicted in FIG. 3G. For example, representative image 355 of FIG. 3F may correspond with representative image 365 of FIG. 3G. As can be seen, the entirety of representative image 365 is displayed on display 362 in the example of FIG. 3G. In this manner, cross-criteria ordered set representation 363 may comprise one or more representative images in addition to the representative images illustrated in the example of FIG. 3G, but such additional representative images may fail to be displayed on display 362 based, at least in part, on a size of display 362, on a size of cross-criteria ordered set representation 363, on a size of each of the representative images comprised by cross-criteria ordered set representation 363, and/or the like. As such, cross-criteria ordered set representation 363 of FIG. 3G may correspond with cross-criteria ordered set representation 353 of FIG. 3F subsequent to determination of and display of a different portion of the cross-criteria ordered set representation. For example, cross-criteria ordered set representation 353 of FIG. 3F may be a portion of a particular cross-criteria ordered set representation, and cross-criteria ordered set representation 363 of FIG. 3G may be a different portion of the particular cross-criteria ordered set representation.

In some circumstances, it may be desirable to display of a cross-criteria ordered set representation, to initiate display of a cross-criteria ordered set representation, and/or the like. In such circumstances, a user of the electronic apparatus may desire such display of the cross-criteria ordered set representation to be performed in a manner which is aesthetically appealing, visually smooth, and/or the like. As such, it may be desirable to animate a transition to display of a cross-criteria ordered set representation, a transition between an absence of display of a cross-criteria ordered set representation and display of the cross-criteria ordered set representation, and/or the like. In at least one example embodiment, display of a cross-criteria ordered set representation comprises display of at least a portion of the cross-criteria ordered set representation on at least a portion of the display that is downward from the center of the media item rendering region of the display. In such an example, the apparatus may cause display of the portion of the cross-criteria ordered set representation at a first position on the display and, subsequently, cause display of the portion of the cross-criteria ordered set representation at a second position on the display, such that the cross-criteria ordered set representation transitions from the second position to the second position in an upward direction. In this manner, the cross-criteria ordered set representation may appear to transition onto the display from the bottom edge of the display in an upward direction, until the entirety of the portion of the cross-criteria ordered set representation is displayed.

FIG. 3H is a diagram illustrating a cross-criteria ordered set representation according to at least one example embodiment. The example of FIG. 3H illustrates apparatus 371. As can be seen, apparatus 371 comprises display 372. In the example of FIG. 3H, apparatus 371 is oriented similar to apparatus 212 of FIG. 2B. As illustrated, media item rendering region 373 of display 372 is associated with a rendering of a snowboarder. In the example of FIG. 3H, the rendering of the snowboarder may be associated with rendering of an image media item, rendering of a frame of a video media item, and/or the like. As can be seen, the rendering of the snowboarder in FIG. 3H corresponds with the rendering of the snowboarder in FIG. 3B, FIG. 3C, and/or the like. In the example of FIG. 3H, portion 374 of display 372 is transitioning from display of criteria ordered set 324 of FIG. 3C to display of cross-criteria ordered set 353 of FIG. 3F. For example, representative image 375 of FIG. 3H may correspond with representative image 325 of FIG. 3C, representative image 354 of FIG. 3F, and/or the like. In this manner, FIG. 3H may depict a particular step in the transition from the display of representative image 325 of FIG. 3C at the position depicted in FIG. 3C to the display of representative image 354 of FIG. 3F at the position depicted in FIG. 3F. In this manner, representative image 375 of FIG. 3H may slide down and to the left as the apparatus transitions to display of the cross-criteria ordered set representation.

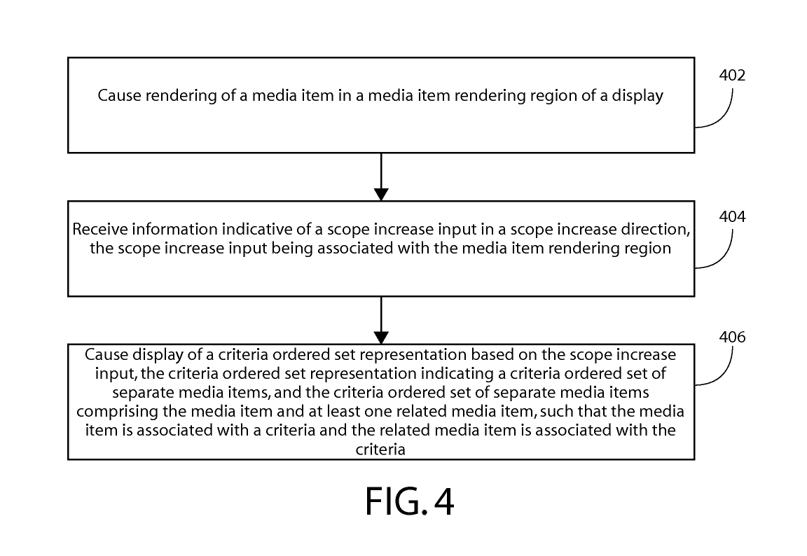

FIG. 4 is a flow diagram illustrating activities associated with causation of display of a criteria ordered set representation based, at least in part, on a scope increase input according to at least one example embodiment. In at least one example embodiment, there is a set of operations that corresponds with the activities of FIG. 4. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 4.

In some circumstances, a user may desire to transition from viewing of a media item to viewing of a criteria ordered set representation. For example, the user may desire to navigate to a different media item that is related to the media item currently being rendered, that is associated with a criteria that is associated with the media item being rendered, and/or the like. In such circumstances, it may be desirable to configure an apparatus such that the user of the apparatus may indicate such a desire to view additional media items, to increase the scope of the media items being displayed by way of a representative image, and/or the like. In at least one example embodiment, an apparatus receives information indicative of a scope increase input in a scope increase direction. The scope increase input may, for example, be associated with a media item rendering region of a display. In at least one example embodiment, the scope increase input is a pinch input. In such an example, the pinch input may comprise a contact portion of the pinch input, another contact portion of the pinch input, and a movement portion of the pinch input. In such an example, the scope increase direction may be an outward direction such that the contact portion of the pinch input moves further from the other contact portion of the pinch input during the movement portion of the pinch input. In at least one example embodiment, the scope increase input is a drag input. In such an example embodiment, the drag input may comprise a contact portion of the drag input, a movement portion of the drag input, and a release portion of the drag input. In such an example embodiment, the scope increase direction may be an upward direction with respect to an orientation of the display such that the release portion of the drag input corresponds with a position that is above a different position that corresponds with the contact portion of the drag input.

For example, a user may be viewing a media item that is rendered in a media item rendering region of a display. In such an example, the user may desire to view a criteria ordered set representation, browse through related media items, and/or the like. As such, it may be desirable to cause display of the criteria ordered set representation such that a user of the apparatus may browse through related media items, identify various media items by way of a representative images, and/or the like. In at least one example embodiment, an apparatus causes display of a criteria ordered set representation based, at least in part, on the scope increase input. The criteria ordered set representation may, for example, overlay a portion of the media item rendering region that is in a direction from a center of the media item rendering region that is opposite the scope increase direction. For example, the scope increase direction may be an upward direction, and the criteria ordered set representation may overlay a portion of the media item rendering region that is downward from a center of the media item rendering region. In at least one example embodiment, the causation of display of the criteria ordered set representation is performed absent intervening inputs between the receipt of the information indicative of the scope increase input and the causation of display of the criteria ordered set representation.

In some circumstances, a user may desire to utilize a majority of a display to render a particular media item. For example, an apparatus may display a criteria ordered set representation such that the criteria ordered set representation overlays at least a portion of a media item rendering region of the display. In such an example, the user may desire to terminate display of the criteria ordered set representation such that the media item rendering region of the display avoid obstruction by the criteria ordered set representation, may resize to a larger size, and/or the like. In at least one example embodiment, an apparatus receives information indicative of a tap input that corresponds with the media item rendering region of the display. In such an example embodiment, the apparatus may cause termination of display of the criteria ordered set representation based, at least in part, on the tap input.

For example, a user may be viewing display 322 of FIG. 3C. As can be see, criteria ordered set representation 324 overlays a portion of media item rendering region 323. In such an example, the user may desire to cause termination of display of criteria ordered set representation 324. As such, apparatus 321 may receive information indicative of a tap input at a position that corresponds with media item rendering region 323, and may cause termination of display of criteria ordered set representation 324. Subsequent to termination of display of criteria ordered set representation 324, display 322 of FIG. 3C may correspond with display 312 of FIG. 3B.

At block 402, the apparatus causes rendering of a media item in a media item rendering region of a display. The causation, the rendering, the display, the media item, and the media item rendering region of the display may be similar as described regarding FIGS. 2A-2B and FIGS. 3A-3H.

At block 404, the apparatus receives information indicative of a scope increase input in a scope increase direction, the scope increase input being associated with the media item rendering region.

At block 406, the apparatus causes display of a criteria ordered set representation based, at least in part, on the scope increase input. In at least one example embodiment, the criteria ordered set representation indicate a criteria ordered set of separate media items. In at least one example embodiment, the criteria ordered set of separate media items comprise the media item and at least one related media item, such that the media item is associated with a criteria and the related media item is associated with the criteria. The causation, the display, the criteria ordered set representation, the criteria ordered set of separate media items, the related media item, and the criteria may be similar as described regarding FIGS. 2A-2B and FIGS. 3A-3H.

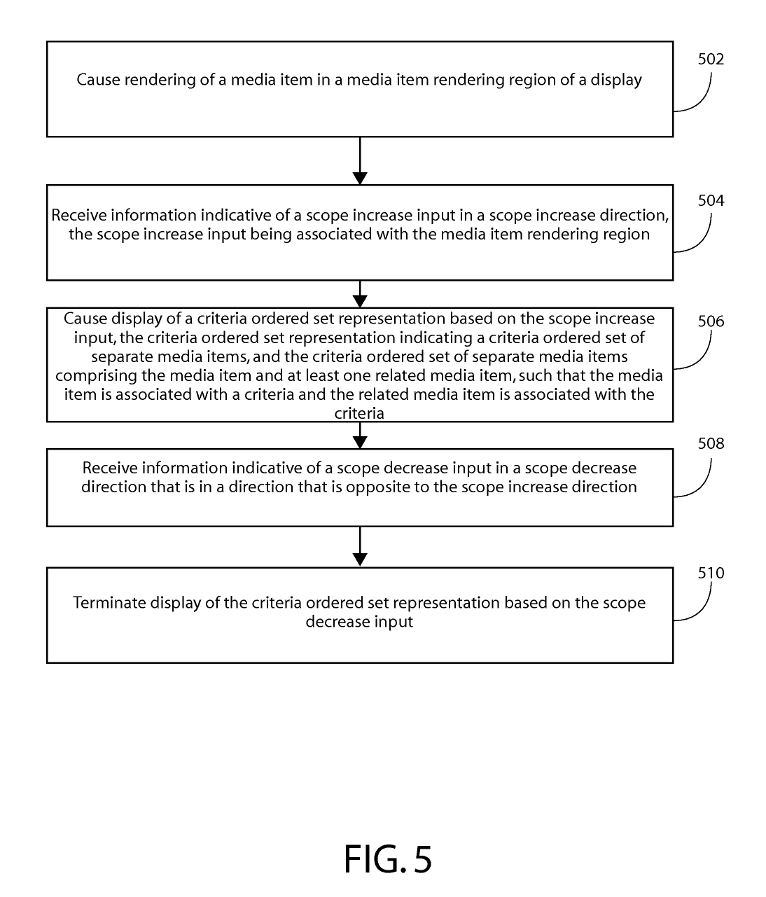

FIG. 5 is a flow diagram illustrating activities associated with termination of display of a criteria ordered set representation based, at least in part, on a scope decrease input according to at least one example embodiment. In at least one example embodiment, there is a set of operations that corresponds with the activities of FIG. 5. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 5.

In some circumstances, a user may desire to transition from viewing of a criteria ordered set representation on a display to viewing of a media item rendering region of the display. For example, an apparatus may display a criteria ordered set representation such that the criteria ordered set representation overlays at least a portion of a media item rendering region of the display. In such an example, the user may desire to terminate display of the criteria ordered set representation such that the media item rendering region of the display avoid obstruction by the criteria ordered set representation, may resize to a larger size, and/or the like. In at least one example embodiment, an apparatus receives information indicative of a scope decrease input, and terminates display of the criteria ordered set representation based, at least in part, on the scope decrease input. In such an example embodiment, the scope decrease input may be in a scope decrease direction that is in a direction that is opposite to the scope increase direction. The scope decrease input may be associated with the criteria ordered set representation, the media item rendering region, and/or the like. For example, the scope decrease input may be at a position that corresponds with the criteria ordered set representation, the media item rendering region, and/or the like. In at least one example embodiment, the scope decrease input is a pinch input. In such an example embodiment, the pinch input may comprise a contact portion of the pinch input, another contact portion of the pinch input, and a movement portion of the pinch input. In such an example embodiment, the scope decrease direction may be an inward direction such that the contact portion of the pinch input moves closer to the other contact portion of the pinch input during the movement portion of the pinch input. In at least one example embodiment, the scope decrease input is a drag input. In such an example embodiment, the drag input may comprise a contact portion of the drag input, a movement portion of the drag input, and a release portion of the drag input. In such an example embodiment, the scope decrease direction may be a downward direction with respect to an orientation of the display such that the release portion of the drag input corresponds with a position that is below a different position that corresponds with the contact portion of the drag input.

For example, a user may be viewing display 322 of FIG. 3C. As can be see, criteria ordered set representation 324 overlays a portion of media item rendering region 323. In such an example, the user may desire to cause termination of display of criteria ordered set representation 324. As such, apparatus 321 may receive information indicative of a tap input at a position that corresponds with media item rendering region 323, and may cause termination of display of criteria ordered set representation 324. Subsequent to termination of display of criteria ordered set representation 324, display 322 of FIG. 3C may correspond with display 312 of FIG. 3B.

At block 502, the apparatus causes rendering of a media item in a media item rendering region of a display. The causation, the rendering, the display, the media item, and the media item rendering region of the display may be similar as described regarding FIGS. 2A-2B and FIGS. 3A-3H.

At block 504, the apparatus receives information indicative of a scope increase input in a scope increase direction, the scope increase input being associated with the media item rendering region. The receipt, the scope increase input, and the scope increase direction may be similar as described regarding FIG. 4.

At block 506, the apparatus causes display of a criteria ordered set representation based, at least in part, on the scope increase input. In at least one example embodiment, the criteria ordered set representation indicate a criteria ordered set of separate media items. In at least one example embodiment, the criteria ordered set of separate media items comprise the media item and at least one related media item, such that the media item is associated with a criteria and the related media item is associated with the criteria. The causation, the display, the criteria ordered set representation, the criteria ordered set of separate media items, the related media item, and the criteria may be similar as described regarding FIGS. 2A-2B and FIGS. 3A-3H.

At block 508, the apparatus receives information indicative of a scope decrease input in a scope decrease direction that is in a direction that is opposite to the scope increase direction.

At block 510, the apparatus terminates display of the criteria ordered set representation based, at least in part, on the scope decrease input. The termination of display of the criteria ordered set representation may be similar as described regarding FIGS. 2A-2B and FIGS. 3A-3H.

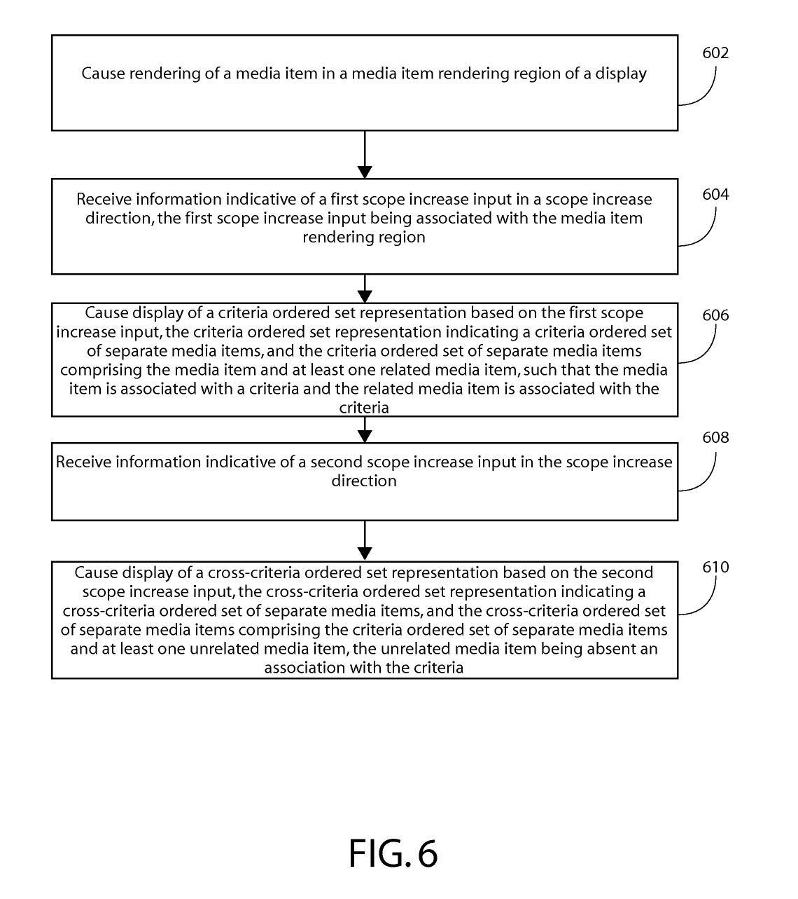

FIG. 6 is a flow diagram illustrating activities associated with causation of display of a cross-criteria ordered set representation based, at least in part, on a scope increase input according to at least one example embodiment. In at least one example embodiment, there is a set of operations that corresponds with the activities of FIG. 6. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 6.

In some circumstances, a user may desire to transition from viewing of a criteria ordered set representation to viewing of a cross-criteria ordered set representation. For example, the user may desire to navigate to a media item that is unrelated to the media item currently being rendered, that is associated with different criteria, that fails to be comprised by the criteria ordered set of separate media items that is indicated by the criteria ordered set representation, and/or the like. In such circumstances, it may be desirable to configure an apparatus such that the user of the apparatus may indicate such a desire to view additional media items, to increase the scope of the media items being displayed by way of a representative image, and/or the like. In at least one example embodiment, an apparatus receives information indicative of a scope increase input in a scope increase direction. The scope increase input may, for example, be associated with a media item rendering region of a display, a criteria ordered set representation, and/or the like. For example, the scope increase input may be at a position that corresponds with a media item rendering region of a display, a criteria ordered set representation, and/or the like. For example, a user may be viewing a media item that is being rendering on a display of an apparatus. In such an example, the user may indicate the user's desire to browse through one or more related media items by way of a first scope increase input. The user may then desire to navigate through one or more unrelated media items, and may indicate such a desire by way of a second scope increase input. In such an example, the apparatus may transition from display of a media item rendering region, to display of a criteria ordered set representation, and to display of a cross-criteria ordered set representation based, at least in part, on the first scope increase input and the second scope increase input.

For example, a user may be viewing display 322 of FIG. 3C. As can be see, criteria ordered set representation 324 overlays a portion of media item rendering region 323. In such an example, navigate to a media item that is unrelated to the media item currently being rendered, that is associated with different criteria, that fails to be comprised by the criteria ordered set of separate media items that is indicated by the criteria ordered set representation, and/or the like. As such, apparatus 321 may receive information indicative of a scope increase input at a position that corresponds with media item rendering region 323, criteria ordered set representation 324, and/or the like, and may cause display of a cross-criteria ordered set representation. Subsequent to display of the cross-criteria ordered set representation, display 322 of FIG. 3C may correspond with display 352 of FIG. 3F.

In some circumstances, a user may be viewing a criteria ordered set representation that is overlain on a media item rendering region of a display. In such circumstances, the user may desire to view a cross-criteria ordered set representation, browse through unrelated media items, and/or the like. As such, it may be desirable to cause display of a cross-criteria ordered set representation such that a user of the apparatus may browse through unrelated media items, identify various media items by way of a representative images, and/or the like. In at least one example embodiment, an apparatus causes display of a cross-criteria ordered set representation based, at least in part, on the scope increase input. In at least one example embodiment, the causation of display of the cross-criteria ordered set representation is performed absent intervening inputs between the receipt of the information indicative of the scope increase input and the causation of display of the cross-criteria ordered set representation.

In some circumstances, it may be desirable to cause display of the cross-criteria ordered set representation such that the cross-criteria ordered set representation utilizes a majority of the display, avoids being obstructed by a criteria ordered set representation, and/or the like. In at least one example embodiment, an apparatus causes termination of display of a criteria ordered set representation. The termination of display of the criteria ordered set representation may be based, at least in part, on the scope increase input, the causation of display of the cross-criteria ordered set representation, and/or the like.

In some circumstances, a user may desire to pan through a cross-criteria ordered set representation quickly and easily. For example, a cross-criteria ordered set representation may be dimensioned such that manually scrolling through the cross-criteria ordered set representation may be an undesirable method to navigate the cross-criteria ordered set representation. In at least one example embodiment, an apparatus causes display of a cross-criteria ordered set representation navigation interface element. The causation of display of a cross-criteria ordered set representation navigation interface element may be based, at least in part, on the causation of display of the cross-criteria ordered set representation, the scope increase input, and/or the like. In such an example embodiment, the apparatus may cause display of an index point at a position along the cross-criteria ordered set representation navigation interface element that is indicative of a scroll position of the cross-criteria ordered set representation, a portion of the cross-criteria ordered set representation that is displayed on a display, and/or the like. In at least one example embodiment, an apparatus receives information indicative of a perpendicular input in a direction that is perpendicular to the scope increase direction. In such an example embodiment, the perpendicular input may be associated with the cross-criteria ordered set representation navigation interface element. In such an example embodiment, the apparatus may cause scrolling of the cross-criteria ordered set representation in proportion to the perpendicular input, in relation to the perpendicular input, and/or the like.

In some circumstances, the user may desire to jump to a particular position within the cross-criteria ordered set representation, to view a particular portion of the cross-criteria ordered set representation, and/or the like. As such, it may be desirable to configure an apparatus such that a user of the apparatus may indicate a particular portion of the cross-criteria ordered set representation that the user's desires to view. In at least one example embodiment, an apparatus receives information indicative of a tap input at a position along the cross-criteria ordered set representation navigation interface element that fails to correspond with a position of an index point along the cross-criteria ordered set representation navigation interface element. In such an example embodiment, the apparatus may cause movement of the index point in relation to the cross-criteria ordered set representation navigation interface element such that the index point moves to a position along the cross-criteria ordered set representation navigation interface element that corresponds with the position of the tap input along the cross-criteria ordered set representation navigation interface element. As such, the indicated position of the index point along the cross-criteria ordered set representation navigation interface element may correspond with a particular portion of the cross-criteria ordered set representation, and may cause display of the particular portion of the cross-criteria ordered set representation.

In some circumstances, a user may desire to transition from viewing of a cross-criteria ordered set representation to viewing of a criteria ordered set representation, a media item rendering region of a display, and/or the like. In at least one example embodiment, an apparatus receives information indicative of a scope decrease input in a scope decrease direction. The scope decrease direction may be a direction that is opposite to the scope increase direction. In such an example embodiment, the apparatus may cause termination of display of a cross-criteria ordered set representation, a criteria ordered set representation, and/or the like, based, at least in part, on the scope decrease input. For example, a user may be viewing display 352 of FIG. 3F. As can be see, cross-criteria ordered set representation 353 is displayed on display 352. In such an example, the user may desire to cause termination of display of cross-criteria ordered set representation 353. As such, apparatus 351 may receive information indicative of a scope decrease input at a position that corresponds with cross-criteria ordered set representation 353, and may cause termination of display of cross-criteria ordered set representation 353. Subsequent to termination of display of cross-criteria ordered set representation 353, display 352 of FIG. 3F may correspond with display 302 of FIG. 3A, with display 322 of FIG. 3C, and/or the like.

At block 602, the apparatus causes rendering of a media item in a media item rendering region of a display. The causation, the rendering, the display, the media item, and the media item rendering region of the display may be similar as described regarding FIGS. 2A-2B and FIGS. 3A-3H.

At block 604, the apparatus receives information indicative of a first scope increase input in a scope increase direction, the first scope increase input being associated with the media item rendering region. The receipt, the first scope increase input, and the scope increase direction may be similar as described regarding FIG. 4.

At block 606, the apparatus causes display of a criteria ordered set representation based, at least in part, on the first scope increase input. In at least one example embodiment, the criteria ordered set representation indicate a criteria ordered set of separate media items. In at least one example embodiment, the criteria ordered set of separate media items comprise the media item and at least one related media item, such that the media item is associated with a criteria and the related media item is associated with the criteria. The causation, the display, the criteria ordered set representation, the criteria ordered set of separate media items, the related media item, and the criteria may be similar as described regarding FIGS. 2A-2B and FIGS. 3A-3H.

At block 608, the apparatus receives information indicative of a second scope increase input in the scope increase direction.

At block 610, the apparatus causes display of a cross-criteria ordered set representation based, at least in part, on the second scope increase input. In at least one example embodiment, the cross-criteria ordered set representation indicates a cross-criteria ordered set of separate media items. In at least one example embodiment, the cross-criteria ordered set of separate media items comprises the criteria ordered set of separate media items and at least one unrelated media item, the unrelated media item being absent an association with the criteria. The causation, the display, the cross-criteria ordered set representation, the cross-criteria ordered set of separate media items, and the unrelated media item may be similar as described regarding FIGS. 2A-2B and FIGS. 3A-3H.

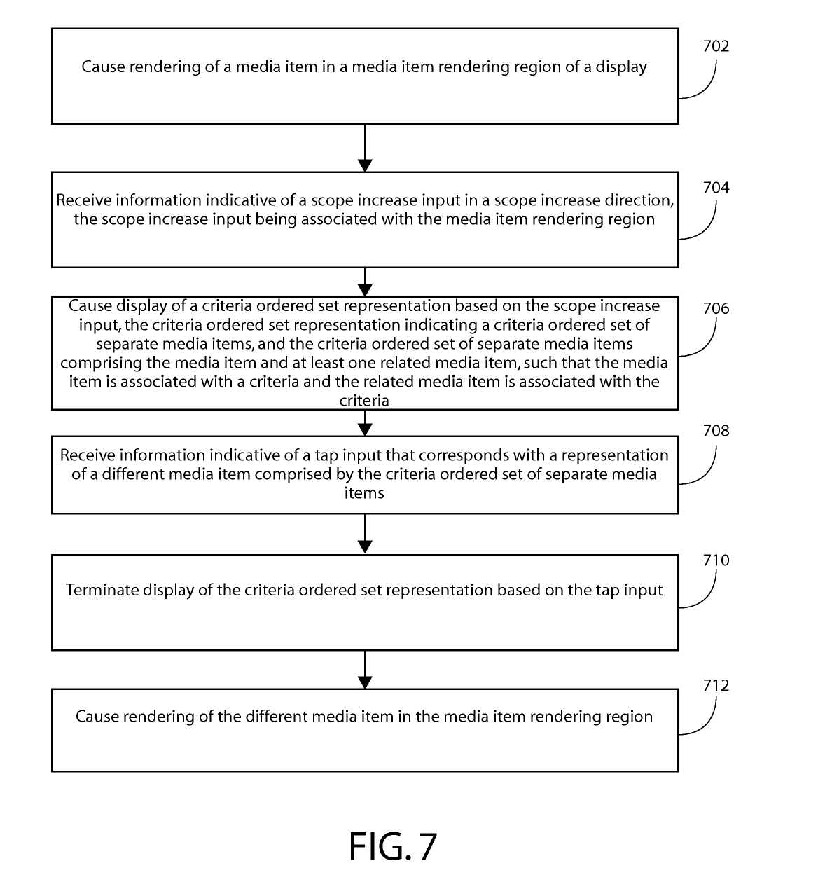

FIG. 7 is a flow diagram illustrating activities associated with causation of rendering of a media item in a media item rendering region according to at least one example embodiment. In at least one example embodiment, there is a set of operations that corresponds with the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 7.

In some circumstances, a user may desire to view a particular media item, to indicate a desire to render a particular media item, and/or the like. In such circumstances, the user may desire to indicate such a desire by way of a representative image that represents the particular media item. As such, it may be desirable to configure an apparatus such that a user of the apparatus may indicate such a desire. In at least one example embodiment, an apparatus receives information indicative of a tap input that corresponds with a representation of a different media item. The different media item may be comprised by a criteria ordered set representation, a cross-criteria ordered set representation, and/or the like. In such an example embodiment, the apparatus may cause rendering of the different media item in the media item rendering region. In circumstances in which the representative image is comprised by a criteria ordered set representation, the apparatus may cause termination of display of the criteria ordered set representation based, at least in part, on the tap input. In circumstances in which the representative image is comprised by a cross-criteria ordered set representation, the apparatus may cause termination of display of the cross-criteria ordered set representation based, at least in part, on the tap input. In this manner, the user may view the media item by way of the media item rendering region of the display without obstruction associated with display of the criteria ordered set representation, display of the cross-criteria ordered set representation, and/or the like.

At block 702, the apparatus causes rendering of a media item in a media item rendering region of a display. The causation, the rendering, the display, the media item, and the media item rendering region of the display may be similar as described regarding FIGS. 2A-2B and FIGS. 3A-3H.

At block 704, the apparatus receives information indicative of a scope increase input in a scope increase direction, the scope increase input being associated with the media item rendering region. The receipt, the scope increase input, and the scope increase direction may be similar as described regarding FIG. 4.

At block 706, the apparatus causes display of a criteria ordered set representation based, at least in part, on the scope increase input. In at least one example embodiment, the criteria ordered set representation indicate a criteria ordered set of separate media items. In at least one example embodiment, the criteria ordered set of separate media items comprise the media item and at least one related media item, such that the media item is associated with a criteria and the related media item is associated with the criteria. The causation, the display, the criteria ordered set representation, the criteria ordered set of separate media items, the related media item, and the criteria may be similar as described regarding FIGS. 2A-2B and FIGS. 3A-3H.

At block 708, the apparatus receives information indicative of a tap input that corresponds with a representation of a different media item comprised by the criteria ordered set. The different media item and the representation of the different media item may be similar as described regarding FIGS. 3A-3H.

At block 710, the apparatus terminates display of the criteria ordered set representation based, at least in part, on the tap input. The termination of display of the criteria ordered set representation may be similar as described regarding FIGS. 3A-3H.

At block 712, the apparatus causes rendering of the different media item in the media item rendering region. The causation, and the rendering of the different media item may be similar as described regarding FIGS. 3A-3H.

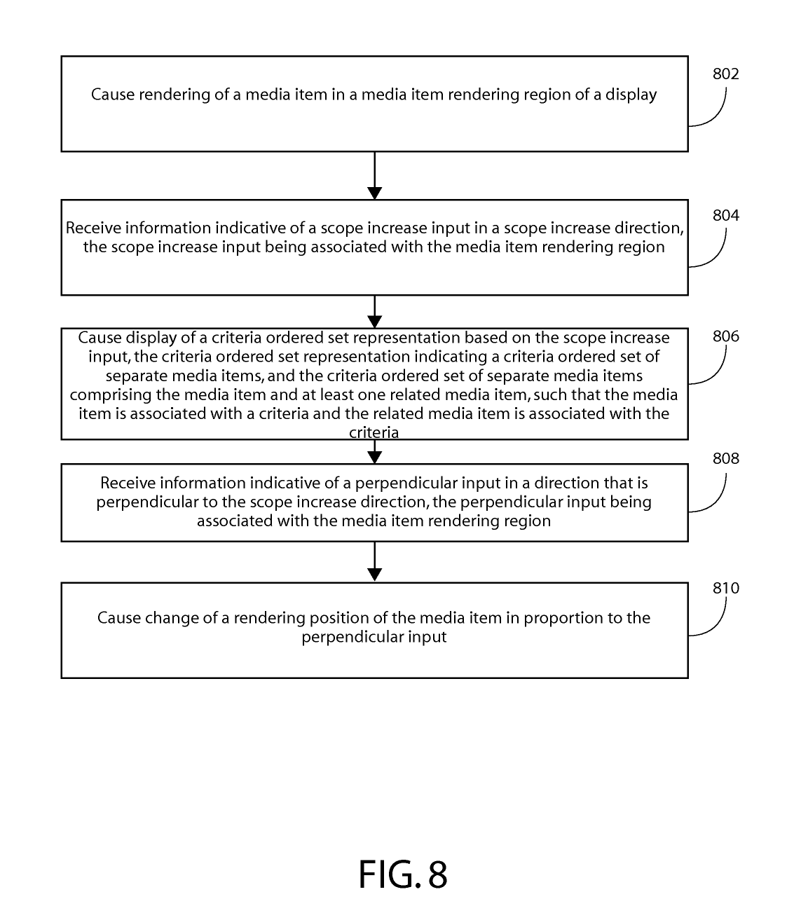

FIG. 8 is a flow diagram illustrating activities associated with causation of changing of a rendering position of a media item in proportion to a perpendicular input according to at least one example embodiment. In at least one example embodiment, there is a set of operations that corresponds with the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 8.

In many circumstances, an apparatus may be caused to render a video media item. In such circumstances, a user may desire to navigate through the video media item by way of the user's electronic apparatus, one or more interface elements, and/or the like. For example, the user may desire to fast forward through a portion of the video media item, rewind through a portion of the video media item, indicate a desired playback position within the video media item, and/or the like. In such circumstances, it may be desirable to configure the electronic apparatus such that the electronic apparatus may fast forward through a portion of the video media item, rewind through a portion of the video media item, jump to a specific playback position within the video media item, and/or the like. In at least one example embodiment, an apparatus receives information indicative of a perpendicular input in a direction that is perpendicular to the scope increase direction. In such an example embodiment, the perpendicular input may be associated with the media item rendering region. In such an example embodiment, the apparatus may cause change of a rendering position of the media item in proportion to the perpendicular input, and cause rendering of a portion of the media item indicated by the rendering position. For example, the rendering position may designate a part of the media item to be rendered such that the apparatus causes rendering of the part of the media item. In another example, the rendering position may designate a timestamp of the media item, and causation of rendering of the portion of the media item indicated by the rendering position may comprise rendering of a frame of the media item that corresponds with the timestamp of the media item.

At block 802, the apparatus causes rendering of a media item in a media item rendering region of a display. The causation, the rendering, the display, the media item, and the media item rendering region of the display may be similar as described regarding FIGS. 2A-2B and FIGS. 3A-3H.

At block 804, the apparatus receives information indicative of a scope increase input in a scope increase direction, the scope increase input being associated with the media item rendering region. The receipt, the scope increase input, and the scope increase direction may be similar as described regarding FIG. 4.

At block 806, the apparatus causes display of a criteria ordered set representation based, at least in part, on the scope increase input. In at least one example embodiment, the criteria ordered set representation indicate a criteria ordered set of separate media items. In at least one example embodiment, the criteria ordered set of separate media items comprise the media item and at least one related media item, such that the media item is associated with a criteria and the related media item is associated with the criteria. The causation, the display, the criteria ordered set representation, the criteria ordered set of separate media items, the related media item, and the criteria may be similar as described regarding FIGS. 2A-2B and FIGS. 3A-3H.

At block 808, the apparatus receives information indicative of a perpendicular input in a direction that is perpendicular to the scope increase direction. In at least one example embodiment, the perpendicular input is associated with the media item rendering region.

At block 810, the apparatus causes changing of a rendering position of the media item in proportion to the perpendicular input. The causation, the rendering position, and the changing of the rendering position may be similar as described regarding FIGS. 3A-3H.

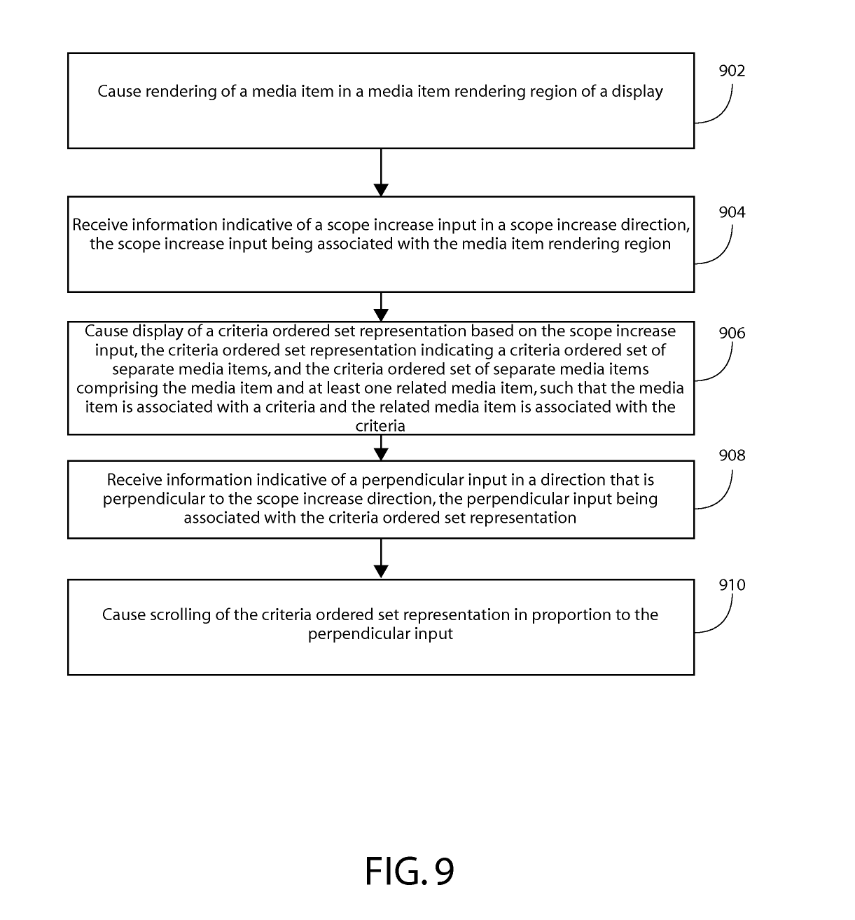

FIG. 9 is a flow diagram illustrating activities associated with causation of scrolling of a criteria ordered set representation in proportion to a perpendicular input according to at least one example embodiment. In at least one example embodiment, there is a set of operations that corresponds with the activities of FIG. 9. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 9.

In some circumstances, a criteria ordered set representation may be dimensioned such that an electronic apparatus may be precluded from displaying of the entirety of the criteria ordered set representation. For example, the criteria ordered set representation may be too wide to be displayed in its entirety on a display of the electronic apparatus, may be too tall to be displayed in its entirety on the display, and/or the like. As such, it may be desirable to configure an electronic apparatus such that the electronic apparatus may display a portion of a criteria ordered set representation in a manner that allows for navigation within the criteria ordered set representation, display of a different portion of the criteria ordered set representation, and/or the like. In at least one example embodiment, an apparatus receives information indicative of a perpendicular input in a direction that is perpendicular to the scope increase direction. In such an example embodiment, the perpendicular input may be associated with a criteria ordered set representation. In such an example embodiment, the apparatus may cause scrolling of the criteria ordered set representation in proportion to the perpendicular input. The scrolling of the criteria ordered set representation may comprise panning of the criteria ordered set representation. For example, the causation of display of the criteria ordered set representation may comprise display of a portion of the criteria ordered set representation, and panning of the criteria ordered set representation may comprise determination of a different portion of the criteria ordered set representation and display of the different portion of the criteria ordered set representation.

In some circumstances, a cross-criteria ordered set representation may be dimensioned such that an electronic apparatus may be precluded from displaying of the entirety of the cross-criteria ordered set representation. For example, the cross-criteria ordered set representation may be too wide to be displayed in its entirety on a display of the electronic apparatus, may be too tall to be displayed in its entirety on the display, and/or the like. As such, it may be desirable to configure an electronic apparatus such that the electronic apparatus may display a portion of a cross-criteria ordered set representation in a manner that allows for navigation within the cross-criteria ordered set representation, display of a different portion of the cross-criteria ordered set representation, and/or the like. In at least one example embodiment, an apparatus receives information indicative of a perpendicular input in a direction that is perpendicular to the scope increase direction. In such an example embodiment, the perpendicular input may be associated with the cross-criteria ordered set representation. In such an example embodiment, the apparatus may cause scrolling of the cross-criteria ordered set representation in proportion to the perpendicular input. In such an example embodiment, the scrolling of the cross-criteria ordered set representation may comprise panning of the cross-criteria ordered set representation. For example, the causation of display of the cross-criteria ordered set representation may comprise display of a portion of the cross-criteria ordered set representation, and panning of the cross-criteria ordered set representation may comprise determination of a different portion of the cross-criteria ordered set representation and display of the different portion of the cross-criteria ordered set representation.

At block 902, the apparatus causes rendering of a media item in a media item rendering region of a display. The causation, the rendering, the display, the media item, and the media item rendering region of the display may be similar as described regarding FIGS. 2A-2B and FIGS. 3A-3H.

At block 904, the apparatus receives information indicative of a scope increase input in a scope increase direction, the scope increase input being associated with the media item rendering region. The receipt, the scope increase input, and the scope increase direction may be similar as described regarding FIG. 4.

At block 906, the apparatus causes display of a criteria ordered set representation based, at least in part, on the scope increase input. In at least one example embodiment, the criteria ordered set representation indicate a criteria ordered set of separate media items. In at least one example embodiment, the criteria ordered set of separate media items comprise the media item and at least one related media item, such that the media item is associated with a criteria and the related media item is associated with the criteria. The causation, the display, the criteria ordered set representation, the criteria ordered set of separate media items, the related media item, and the criteria may be similar as described regarding FIGS. 2A-2B and FIGS. 3A-3H.

At block 908, the apparatus receives information indicative of a perpendicular input in a direction that is perpendicular to the scope increase direction. In at least one example embodiment, the perpendicular input is associated with the criteria ordered set representation.

At block 910, the apparatus causes scrolling of the criteria ordered set representation in proportion to the perpendicular input. The causation and the scrolling of the criteria ordered set representation may be similar as described regarding FIGS. 3A-3H.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 508 and block 510 of FIG. 5 may be performed before block 502 of FIG. 5. Furthermore, if desired, one or more of the above-described functions may be optional or may be combined. For example, block 710 of FIG. 7 may be optional and/or combined with block 712 of FIG. 7.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

What is claimed is:

1. An apparatus, comprising:
at least one processor;
at least one memory including computer program code, the memory and the computer program code configured to, working with the processor, cause the apparatus to perform at least the following:
causation of rendering of a media item in a media item rendering region of a display;
receipt of information indicative of a first scope increase input in a scope increase direction, the first scope increase input being associated with the media item rendering region; and
causation of display of a criteria ordered set representation based, at least in part, on the first scope increase input, the criteria ordered set representation indicating a criteria ordered set of separate media items, and the criteria ordered set of separate media items comprising the media item and at least one related media item, such that the media item is associated with a criteria and the related media item is associated with the criteria.

2. The apparatus of claim 1, wherein the memory includes computer program code configured to, working with the processor, cause the apparatus to perform:
receipt of information indicative of a tap input that corresponds with a representation of a different media item comprised by the criteria ordered set;
termination of display of the criteria ordered set representation based, at least in part, on the tap input; and
causation of rendering of the different media item in the media item rendering region.

3. The apparatus of claim 1, wherein the memory includes computer program code configured to, working with the processor, cause the apparatus to perform:
receipt of information indicative of a scope decrease input in a scope decrease direction that is in a direction that is opposite to the scope increase direction; and
termination of display of the criteria ordered set representation based, at least in part, on the scope decrease input.

4. The apparatus of claim 1, wherein the memory includes computer program code configured to, working with the processor, cause the apparatus to perform:
receipt of information indicative of a second scope increase input in the scope increase direction; and
causation of display of a cross-criteria ordered set representation based, at least in part, on the second scope increase input, the cross-criteria ordered set representation indicating a cross-criteria ordered set of separate media items, and the cross-criteria ordered set of separate media items comprising the criteria ordered set of separate media items and at least one unrelated media item, the unrelated media item being absent an association with the criteria.

5. The apparatus of claim 4, wherein the criteria ordered set representation is single row of representative images of a plurality of separate media items comprised by the criteria ordered set, and the cross-criteria ordered set representation is multiple rows of representative images of a plurality of separate media items comprised by the cross-criteria ordered set.

6. The apparatus of claim 4, wherein the memory includes computer program code configured to, working with the processor, cause the apparatus to perform termination of display of the criteria ordered set representation based, at least in part, on the second scope increase input.

7. The apparatus of claim 1, wherein the memory includes computer program code configured to, working with the processor, cause the apparatus to perform:
receipt of information indicative of a perpendicular input in a direction that is perpendicular to the scope increase direction, the perpendicular input being associated with the criteria ordered set representation; and
causation of scrolling of the criteria ordered set representation in proportion to the perpendicular input.

8. The apparatus of claim 1, wherein the memory includes computer program code configured to, working with the processor, cause the apparatus to perform:
receipt of information indicative of a perpendicular input in a direction that is perpendicular to the scope increase direction, the perpendicular input being associated with the media item rendering region; and
causation of change of a rendering position of the media item in proportion to the perpendicular input.

9. The apparatus of claim 1, wherein the causation of display of the criteria ordered set representation comprises overlay of the criteria ordered set representation on a portion of the media item rendering region that is in a direction from a center of the media item rendering region that is opposite the scope increase direction.

10. A method comprising:
causing rendering of a media item in a media item rendering region of a display;
receiving information indicative of a first scope increase input in a scope increase direction, the first scope increase input being associated with the media item rendering region; and
causing display of a criteria ordered set representation based, at least in part, on the first scope increase input, the criteria ordered set representation indicating a criteria ordered set of separate media items, and the criteria ordered set of separate media items comprising the media item and at least one related media item, such that the media item is associated with a criteria and the related media item is associated with the criteria.

11. The method of claim 10, further comprising:
receiving information indicative of a tap input that corresponds with a representation of a different media item comprised by the criteria ordered set;
terminating display of the criteria ordered set representation based, at least in part, on the tap input; and
causing rendering of the different media item in the media item rendering region.

12. The method of claim 10, further comprising:
receiving information indicative of a scope decrease input in a scope decrease direction that is in a direction that is opposite to the scope increase direction; and
terminating display of the criteria ordered set representation based, at least in part, on the scope decrease input.

13. The method of claim 10, further comprising:
receiving information indicative of a second scope increase input in the scope increase direction; and
causing display of a cross-criteria ordered set representation based, at least in part, on the second scope increase input, the cross-criteria ordered set representation indicating a cross-criteria ordered set of separate media items, and the cross-criteria ordered set of separate media items comprising the criteria ordered set of separate media items and at least one unrelated media item, the unrelated media item being absent an association with the criteria.

14. The method of claim 13, wherein the criteria ordered set representation is single row of representative images of a plurality of separate media items comprised by the criteria ordered set, and the cross-criteria ordered set representation is multiple rows of representative images of a plurality of separate media items comprised by the cross-criteria ordered set.

15. The method of claim 10, further comprising:
receiving information indicative of a perpendicular input in a direction that is perpendicular to the scope increase direction, the perpendicular input being associated with the criteria ordered set representation; and
causing scrolling of the criteria ordered set representation in proportion to the perpendicular input.

16. The method of claim 10, further comprising:
receiving information indicative of a perpendicular input in a direction that is perpendicular to the scope increase direction, the perpendicular input being associated with the media item rendering region; and
causing change of a rendering position of the media item in proportion to the perpendicular input.

17. At least one computer-readable medium encoded with instructions that, when executed by a processor, perform:
causation of rendering of a media item in a media item rendering region of a display;
receipt of information indicative of a first scope increase input in a scope increase direction, the first scope increase input being associated with the media item rendering region; and
causation of display of a criteria ordered set representation based, at least in part, on the first scope increase input, the criteria ordered set representation indicating a criteria ordered set of separate media items, and the criteria ordered set of separate media items comprising the media item and at least one related media item, such that the media item is associated with a criteria and the related media item is associated with the criteria.

18. The medium of claim 17, further encoded with instructions that, when executed by a processor, perform:
receipt of information indicative of a tap input that corresponds with a representation of a different media item comprised by the criteria ordered set;
termination of display of the criteria ordered set representation based, at least in part, on the tap input; and
causation of rendering of the different media item in the media item rendering region.

19. The medium of claim 17, further encoded with instructions that, when executed by a processor, perform:
receipt of information indicative of a scope decrease input in a scope decrease direction that is in a direction that is opposite to the scope increase direction; and
termination of display of the criteria ordered set representation based, at least in part, on the scope decrease input.

20. The medium of claim 17, further encoded with instructions that, when executed by a processor, perform:
receipt of information indicative of a second scope increase input in the scope increase direction; and
causation of display of a cross-criteria ordered set representation based, at least in part, on the second scope increase input, the cross-criteria ordered set representation indicating a cross-criteria ordered set of separate media items, and the cross-criteria ordered set of separate media items comprising the criteria ordered set of separate media items and at least one unrelated media item, the unrelated media item being absent an association with the criteria.
